(19) United States
(12) Patent Application Publication
(10) Pub. No.: US 2015/0103898 A1
(43) Pub. Date: Apr. 16, 2015

(54) WEIGHTED PREDICTION PARAMETER SIGNALING FOR VIDEO CODING

(71) Applicant: Vid Scale, Inc., Wilmington, DE (US)

(72) Inventors: Yan Ye, San Diego, CA (US); Jie Dong, San Diego, CA (US); Yong He, San Diego, CA (US); Eun Ryu, Seoul (KR)

(21) Appl. No.: 14/391,652

(22) PCT Filed: Apr. 9, 2013
(86) PCT No.: PCT/US2013/035698

§ 371 Date: Oct. 9, 2014

Related U.S. Application Data
(60) Provisional application No. 61/622,001, filed on Apr. 9, 2012.
(60) Provisional application No. 61/625,579, filed on Apr. 17, 2012.
(60) Provisional application No. 61/666,718, filed on Jun. 29, 2012.

(51) Int. Cl. H04N 19/50

(52) U.S. Cl. CPC H04N 19/50
USPC 375/240.12

(57) ABSTRACT

Systems, methods, and instrumentalities are provided to implement weighted prediction (WP) signaling, A decoding device may receive a plurality of first list WP parameters, and a. weights present flag. The weights present flag may indicate whether a plurality of second list WP parameters are signaled. The decoding device may receive the second list WP parameters when the weights present flag indicates that the second list WP parameters are signaled. The plurality of second list WP parameters may be derived when the weights present flag indicates that the second list WP parameters are not signaled. The decoding device may receive a delta parameter present, flag, which may indicate whether a plurality of delta WP parameters are signaled. The decoding device may receive the delta WP parameters, when the delta parameter present flag indicates that the plurality of the delta WP parameters are signaled.

### CROSS REFERENCE TO RELATED APPLICATIONS

This application claims the benefit of U.S. Provisional Patent Application Nos. 61/622,001 filed on Apr. 9, 2012, 61/625,579 filed on Apr. 17, 2012, and 61/666,718 filed on Jun. 29, 2012, the contents of which are hereby incorporated by reference herein.

### BACKGROUND

Multimedia technology and mobile communications have experienced massive growth and commercial success in recent years. Wireless communications technology has dramatically increased the wireless bandwidth and improved the quality of service for mobile users. For example, 3rd Generation Partnership Project (3GPP) Long Term Evolution (LTE) standard has improved the quality of service as compared to 2nd Generation (2G) and/or 3rd Generation (3G).

With the availability of high bandwidths on wireless networks, video and multimedia content that is available on the wired web may drive users to desire equivalent on-demand access to that content from a mobile device. A higher percentage of the world's mobile data traffic is becoming video content. Mobile video has the highest growth rate of any application category measured within the mobile data.

Video coding systems are widely used to compress digital video signals to reduce the storage need and/or transmission bandwidth of such signals. Among the various types of video coding systems, such as block-based, wavelet-based, and object-based systems, nowadays block-based hybrid video coding systems are among the most widely used and deployed. Examples of block-based video coding systems include international video coding standards such as the MPEG1/2/4 part 2, H.264/MPEG-4 part 10 AVC, and VC-1, etc. Although wireless communications technology has dramatically increased the wireless bandwidth and improved the quality of service for users of mobile devices, the fast-growing demand of video content, such as high-definition (HD) video content, over mobile Internet may bring new challenges for mobile video content providers, distributors, and carrier service providers.

### SUMMARY

Systems, methods, and instrumentalities are provided to implement weighted prediction (WP) signaling. A decoding device (e.g., a wireless transmit/receive unit (WTRU), a video phone, a tablet computer, etc.) may receive a plurality of first list (e.g., a list L0) WP parameters, and a weights present flag. The weights present flag may indicate whether a plurality of second list (e.g., a list L1) WP parameters are signaled. The plurality of first list WP parameters, the plurality of second list WP parameters, and the weights present flag may be received via a bitstream. The plurality of first list WP parameters or the plurality of second list WP parameters may comprise one or more of a luma weight, a chroma weight, a luma offset, or a chroma offset.

The decoding device may determine, based on the weights present flag, whether the plurality of second list WP parameters are signaled. The decoding device may receive the plurality of second list WP parameters when the weights present flag indicates that the plurality of second list WP parameters are signaled. The decoding device may derive the plurality of second list WP parameters when the weights present flag indicates that the plurality of second list WP parameters are not signaled. The derivation of the plurality of second list WP parameters may comprise copying the plurality of first list WP parameters to the plurality of second list WP parameters when a first list is identical to a second list, or setting the plurality of second list WP parameters to a plurality of default values, when a first list is not identical to a second list. The first list may be identical to the second list when: size of the first list may be equal to size of the second list, and an entry in the first list and a corresponding entry in the second list refer to the same reference picture in the decoded picture buffer (DPB)) (e.g., each of the first list and corresponding second list entry pairs may refer to the a reference picture in the DPB).

The decoding device may receive a plurality of first list (e.g., a list L0) WP parameters. The decoding device may receive a delta parameter present flag. The delta parameter present flag may indicate whether a plurality of delta WP parameters may be signaled for second list WP parameters. The decoding device may determine, based on the delta parameter present flag, whether the plurality of delta WP parameters may be signaled. The decoding device may receive the plurality of delta WP parameters, when the delta parameter present flag indicates that the plurality of delta WP parameters may be signaled. The decoding device may set the plurality of delta WP parameters to a plurality of fixed values (e.g., 0), when the delta parameter present flag indicates that the plurality of delta WP parameters are not signaled. The decoding device may calculate a plurality of second list (e.g., a list L1) WP parameters by adding each of the plurality of delta WP parameters to a corresponding first list WP parameter.

The decoding device may initialize a WP parameter for a reference picture in a DPB. The decoding device may identify the reference picture in the DPB associated with an entry in a reference picture list and its associated WP parameters. The decoding device may receive a delta WP parameter for the entry in the reference picture list. The decoding device may calculate the WP parameter by adding the delta WP parameter to a corresponding entry associated WP parameter, and assigning the calculated WP parameter to the entry in the reference picture list. The reference picture list may be assigned to a first list, a second list, or a combined list. The decoding device may update the WP parameter for the reference picture in the DPB with the calculated WP parameter.

### BRIEF DESCRIPTION OF THE DRAWINGS

A more detailed understanding may be had from the following description, given by way of example in conjunction with the accompanying drawings.

FIG. 1 illustrates an exemplary video encoding and decoding system.

FIG. 2 illustrates an exemplary block diagram of a video encoding system.

FIG. 3 illustrates an exemplary block diagram of a video decoding system

FIG. 4 illustrates an exemplary motion prediction using motion prediction unit of FIG. 2.

FIG. 5 illustrates an exemplary block-level movement within a picture.

FIG. 6 illustrates an exemplary process to combine lists, e.g., L0 and L1 into a list C (LC).

FIG. 7 illustrates an exemplary list LC that may be identical to the lists L0 and L1.

FIG. 8 illustrates an exemplary flow chart for signaling of weighted parameters (WPs) for lists L0, L1, and LC.

FIG. 9 illustrates an example of “reference picture duplication” incompatibility.

FIG. 10 illustrates an example of short combined list LC incompatibility.

FIG. 11 illustrates an exemplary flow chart of WP signaling.

FIG. 12 illustrates an exemplary reordering process, where the two entries in the lists L0 and L1 may be repeated.

FIG. 12a illustrates an example of reference picture duplication.

FIG. 12b illustrates construction of an array for the prediction structure shown in FIG. 12a.

FIG. 13 illustrates an exemplary prediction structure.

FIG. 14 illustrates an exemplary array representing mapping relationship between the reference picture lists and the physical reference pictures in a decoded picture buffer (DPB).

FIG. 15 illustrates an exemplary flow chart for signaling of WP parameters.

FIG. 16 illustrates an exemplary flow chart for WP parameter prediction.

FIG. 17A is a system diagram of an example communications system in which one or more disclosed embodiments may be implemented.

FIG. 17B is a system diagram of an example wireless transmit/receive unit (WTRU) that may be used within the communications system illustrated in FIG. 17A.

FIG. 17C is a system diagram of an example radio access network and an example core network that may be used within the communications system illustrated in FIG. 17A.

FIG. 17D is a system diagram of another example radio access network and another example core network that may be used within the communications system illustrated in FIG. 17A.

FIG. 17E is a system diagram of another example radio access network and another example core network that may be used within the communications system illustrated in FIG. 17A.

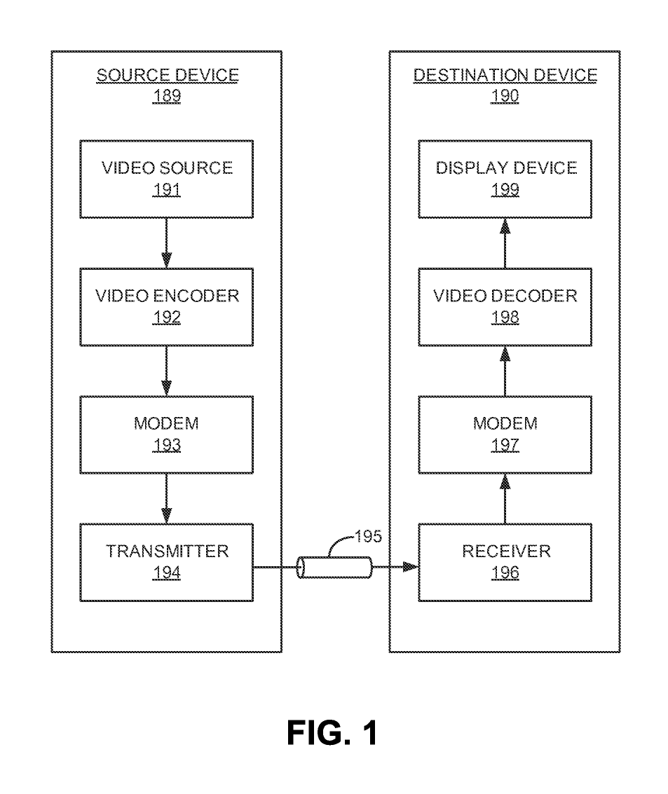

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate flow charts, which are meant to be exemplary. Other embodiments may be used. The order of the messages may be varied where appropriate. Messages may be omitted if not needed, and, additional flows may be added.

A video sequence may include a series of video frames. The video encoder 192 may operate on video blocks within individual video frames in order to encode the video data. The video blocks may have fixed and/or varying sizes, and may differ in size according to a specified coding standard. Each video frame may include a plurality of slices. Each slice may include a plurality of video blocks.

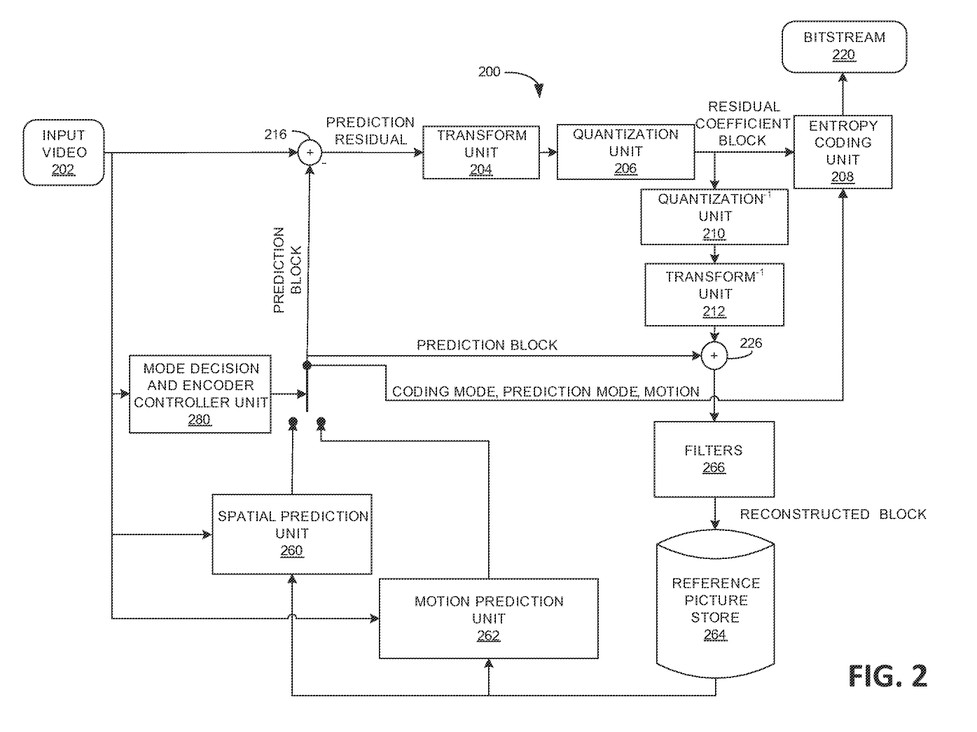

FIG. 2 illustrates an exemplary block diagram of a video encoding system, 200 that may implement motion prediction using the weighted prediction (WP) as described herein. The video encoder 200 may perform intra- and/or inter-coding of blocks within video frames, including video blocks, or partitions or sub-partitions of video blocks. Intra-coding may rely on spatial prediction to reduce or remove spatial redundancy in video within a given video frame. Inter-coding may rely on temporal prediction to reduce or remove temporal redundancy in video within adjacent frames of a video sequence. Intra modes may refer to a number of spatial based compression modes and inter modes such as uni-directional prediction or bi-directional prediction may refer to a number of temporal-based compression modes.

The input video signal 202 may be processed block by block. For example, the video block unit may be a 16 pixels by 16 pixels block (e.g., a macroblock (MB)). In HEVC, extended block sizes (e.g., a coding unit (CU)) may be used to compress video signals of resolution, e.g., 1080p and beyond. In HEVC, a CU may include up to 64×64 pixels. A CU may be partitioned into prediction units (PUs), for which separate prediction methods may be applied. Each input video block (e.g., MB, CU, PU, etc.) may be processed by using spatial prediction unit 260 and/or temporal prediction unit, 262.

Spatial prediction (e.g., intra prediction) may use pixels from the already coded neighboring blocks in the same video picture/slice to predict the current video block. Spatial prediction may reduce spatial redundancy inherent in the video signal. Temporal prediction (e.g., inter prediction or motion compensated prediction) may use pixels from the already coded video pictures to predict the current video block. Temporal prediction may reduce temporal redundancy inherent in the video signal.

Temporal prediction for a video block may be signaled by one or more motion vectors. The motion vectors may indicate the amount and the direction of motion between the current block and one or more of its prediction block(s) in the reference frames. If multiple reference pictures are supported, one or more reference picture indices may be sent for a video block. The one or more reference indices may be used to identify from which reference picture(s) in the reference picture store or Decoded Picture Buffer (DPB) 264, the temporal prediction signal may come. After spatial and/or temporal prediction, the mode decision and encoder controller 280 in the encoder may choose the prediction mode, for example based on a rate-distortion optimization method. The prediction block may be subtracted from the current video block at adder 216. The prediction residual may be transformed by transformation unit 204, and quantized by quantization unit 206. The quantized residual coefficients may be inverse quantized at inverse quantization unit 210 and inverse transformed at inverse transformation unit 212 to form the reconstructed residual. The reconstructed block may be added to the prediction block at adder 226 to form the reconstructed video block. The in-loop filtering, such as deblocking filter and adaptive loop filters 266, may be applied on the reconstructed video block before it is put in the reference picture store 264 and used to code future video blocks. To form the output video bitstream 220, coding mode (e.g., inter or intra), prediction mode information, motion information, and quantized residual coefficients may be sent to the entropy coding unit 208 to be compressed and packed to form the bitstream 220. The systems and methods, and instrumentalities described herein may be implemented, at least partially, within the temporal prediction unit 262.

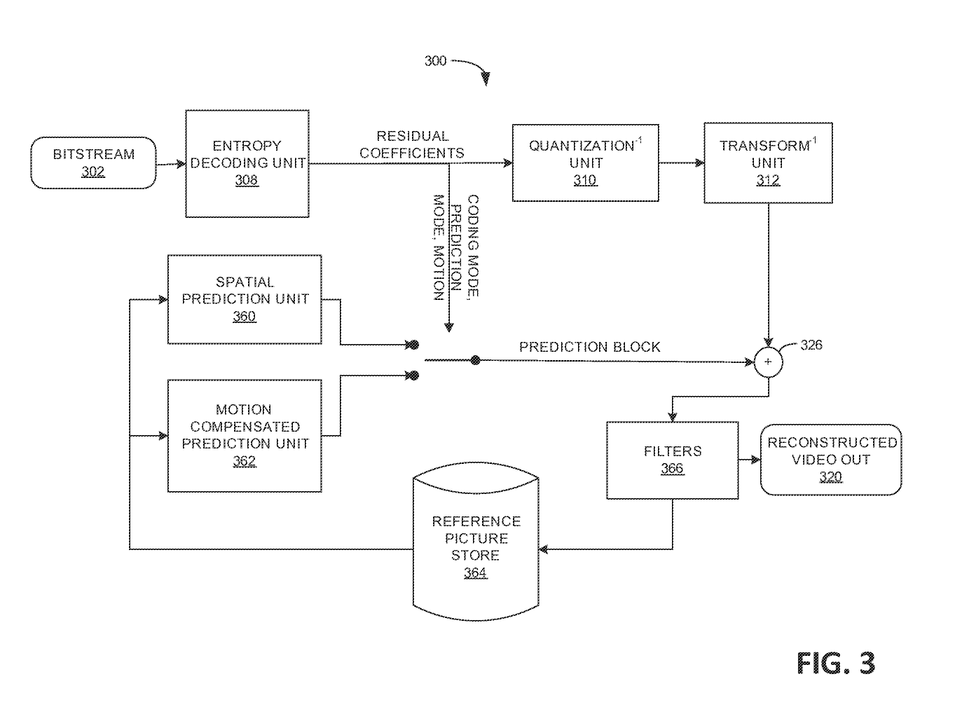

FIG. 3 illustrates an exemplary video decoding system. The video bitstream 302 may be unpacked and entropy decoded at entropy decoding unit 308. The coding mode and prediction information may be sent to the spatial prediction unit 360 (e.g., if intra coded) or the temporal prediction unit 362 (e.g., if inter coded) to form the prediction block. The residual transform coefficients may be sent to inverse quantization unit 310 and inverse transform unit 312 to reconstruct the residual block. The prediction block and the residual block may be added at 326. The reconstructed block may send to the in-loop filtering unit 366 before it may be stored in reference picture store 364. The reconstructed video 320 may be sent to drive a display device, and may be used to predict future video blocks. The terms “temporal prediction.” “motion prediction,” “motion compensated prediction,” and “inter prediction” may be used interchangeably. Methods, systems, and instrumentalities described herein may apply to temporal prediction, e.g., weighted prediction (WP). WP may be supported by H.264/AVC, and HEVC.

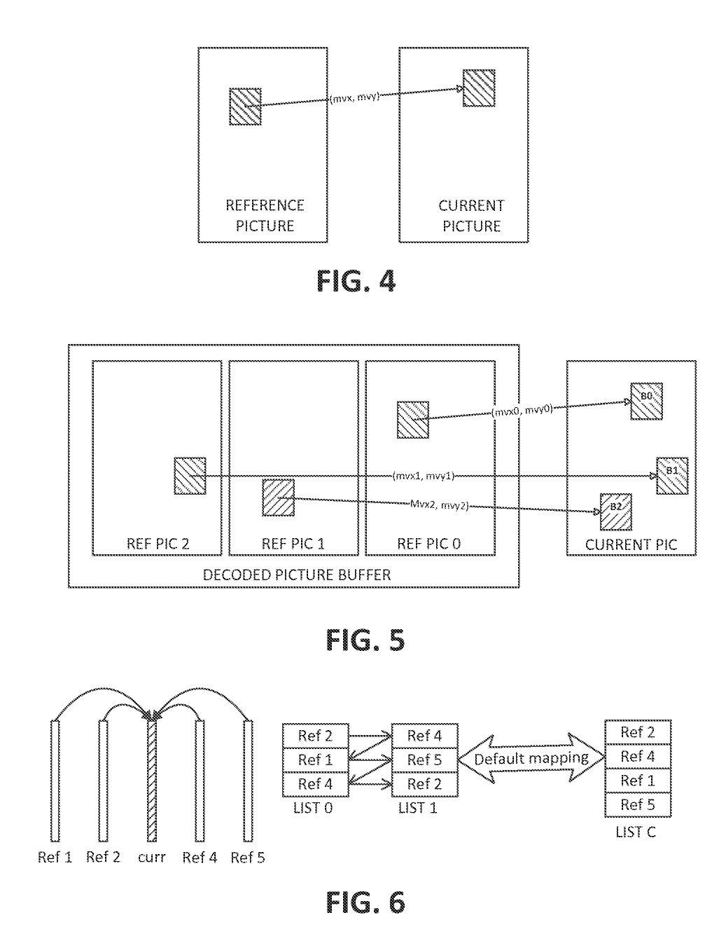

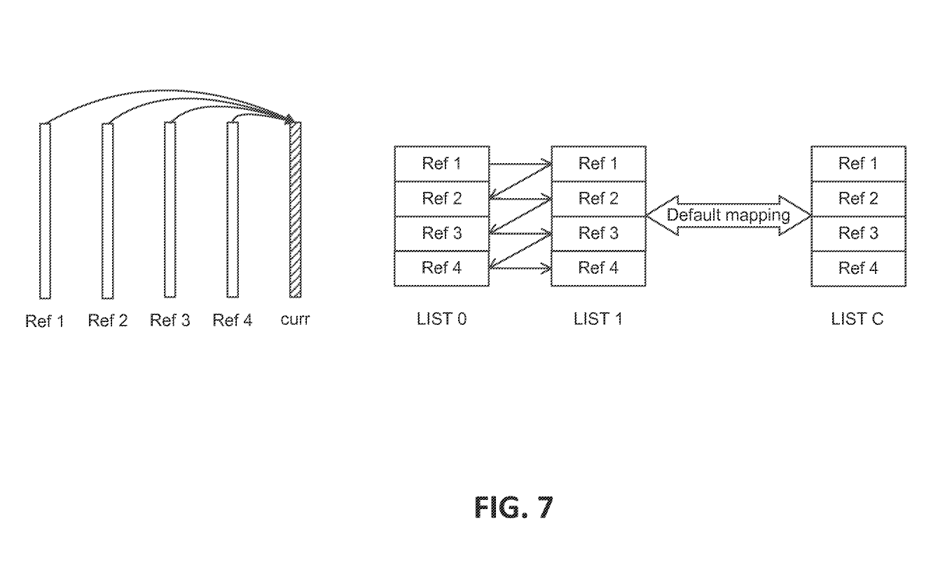

FIG. 4 and FIG. 5 illustrate exemplary motion prediction of video blocks (e.g., using motion prediction unit 262 of FIG. 2). FIG. 5 illustrates a decoded picture buffer including, for example, reference pictures “Ref pic 0,” “Ref pic 1,” and “Ref pic2”. The blocks B0, B1, and B2 in a current picture may be predicted from blocks in reference pictures “Ref pic 0,” “Ref pic 1,” and “Ref pic2” respectively. As illustrated in FIG. 4 and FIG. 5, motion prediction may use video blocks from neighboring video frames to predict the current video block, and may exploit temporal correlation and remove temporal redundancy inherent in the video signal. For example, in H.264/AVC and HEVC, temporal prediction may be performed on video blocks of various sizes (e.g., for the luma component, temporal prediction block sizes may vary from 16×16 to 4×4 in H.264/AVC, and from 64×64 to 4×4 in HEVC). With a motion vector of (mvx, mvy), temporal prediction may be performed as provided by equation (1):

P(x,y)=ref(x−mvx,y−mvy) (1)

where ref(x,y) may be pixel value at location (x, y) in the reference picture, and P(x,y) may be the predicted block. A video coding system may support inter-prediction with fractional pixel precision. When a motion vector (mvx, mvy) has fractional pixel value, interpolation filters may be applied to obtain the pixel values at fractional pixel positions. Block based video coding systems may use multi-hypothesis prediction to improve temporal prediction, where a prediction signal may be formed by combining a number of prediction signals from different reference pictures. For example, H.264/AVC and/or HEVC may use bi-prediction that may combine two prediction signals. Bi-prediction may combine two prediction signals, each from a reference picture, to form a prediction, such as the following equation (2):

$$\begin{matrix}P ( x , y ) = \frac{{P}_{0} ( x , y ) + {P}_{1} ( x , y )}{2} \\ = \frac{{ref}_{0} ( x - {mvx}_{0} , y - {mvy}_{0} ) + {ref}_{1} ( x - {mvx}_{1} , y - {mvy}_{1} )}{2}\end{matrix} \qquad ( 2 )$$

where P₀(x, y) and P₁(x, y) may be the first and the second prediction block, respectively. As illustrated in equation (2), the two prediction blocks may be obtained by performing motion compensated prediction from two reference pictures ref₀(x, y) and ref₁(x, y), with two motion vectors (mvx₀,mvy₀) and (mvx₁,mvy₁) respectively. The prediction block P(x, y) may be subtracted from the source video block at adder 216 of FIG. 2 to form a prediction residual block. The prediction residual block may be transformed at transform unit 204, and quantized at quantization unit 206. The quantized residual transform coefficient blocks may be sent to entropy coding unit 208 to be entropy coded to reduce bit rate. The entropy coded residual coefficients may be packed to form part of an output video bitstream 220.

Along the temporal dimension, video signals may include illumination changes such as fade-in, fade-out, cross-fade, dissolve, flashes, etc. The illumination changes may happen locally (e.g., within a region of a picture) or globally (e.g., within the entire picture). Video coding standards, for example, H.264/AVC and/or HEVC WD4 may allow weighted prediction, such as a linear weighted prediction as provided in equation (3), to improve accuracy of motion prediction for regions with illumination change:

WP(x,y)=w·P(x,y)+o (3)

where P(x, y) and WP(x, y) may be predicted pixel values at location (x, y) before and after weighted prediction, and w and o may be the weight and offset used in weighted prediction. For bi-prediction, equation (4) may be used:

WP(x,y)=w₀·P₀(x,y)+w₁·P₁(x,y)+o₀+o₁ (4)

where P₀(x, y) and P₁(x, y) may be the first and second prediction blocks before weighted prediction, WP(x,y) may be the bi-predictive signal after weighted prediction, w₀ and w₁ may be the weights for each prediction block, and o₀ and o₁ maybe the offsets. To facilitate WP with fixed-point arithmetic, the weights may have fixed-point precisions. For example, for uni-prediction and/or bi-prediction, the following WP processes may be used:

WP(x,y)=((w·P(x,y)+round)>>w_log 2_denom)+o (5)

WP(x,y)=((w₀P(x,y)+w₁P₁(x,y)+((o₀+o₁)<<w_log 2_denom))+round)>>(w_log 2_denom+1)) (6)

where w_log 2_denom is the bit precision of the weighting parameter w and round=(1<<(w_log 2_denom−1)) in (5) and round=(1<<w_log 2_denom) in (6).

Explicit weighted prediction may be provided for P-coded pictures/slices, and explicit and/or implicit weighted prediction may be provided for B-coded pictures/slices. For implicit WP, the weights may be derived based on relative picture coding order (e.g., the temporal distance) between the current picture and its reference picture, and the offsets may be set to 0 (o₀=o₁=0).

Methods, systems, and instrumentalities described herein may be applied to the explicit WP. In explicit WP, the weights and the offsets may be determined, for example, by the encoder. The weights may be signaled to the decoder in the video bitstream. For example, a pair of WP parameters (w,o) may be sent in the bitstream for each reference picture of the current picture and for each color component (e.g., the luma component and two chroma components). Precisions of the weights, w_log 2_den om_luma and w_log 2_den om_chroma, for the luma component, and the chroma components (e.g., two chroma components share the same w_log 2_den om_chroma) may be sent in the bitstream.

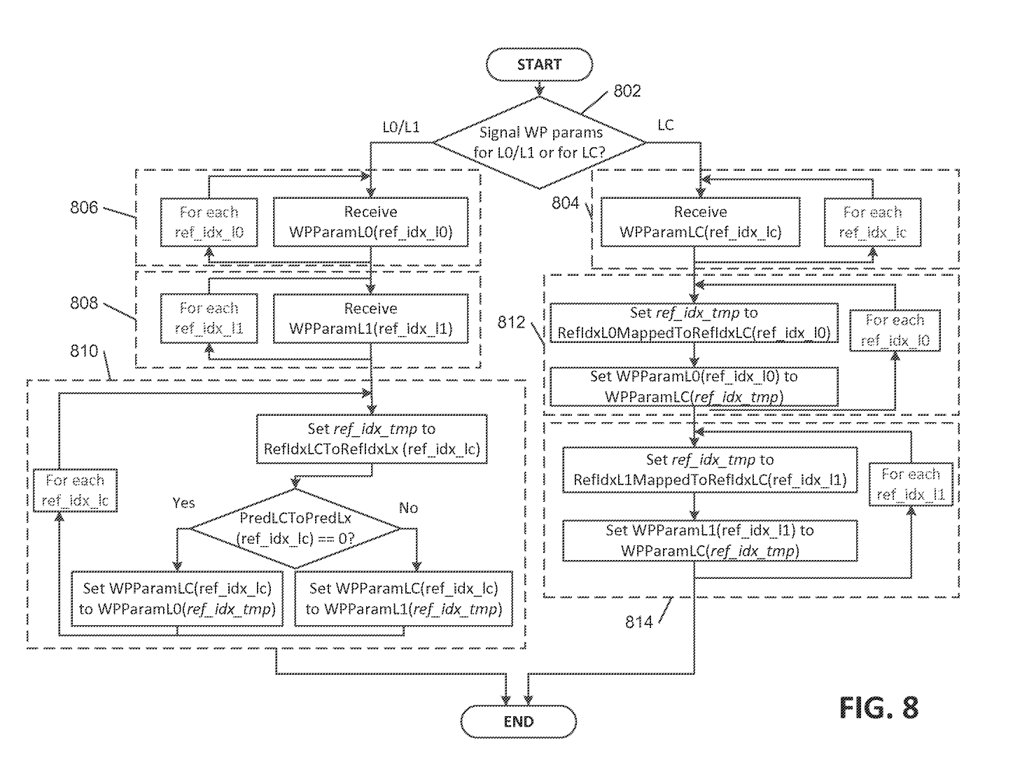

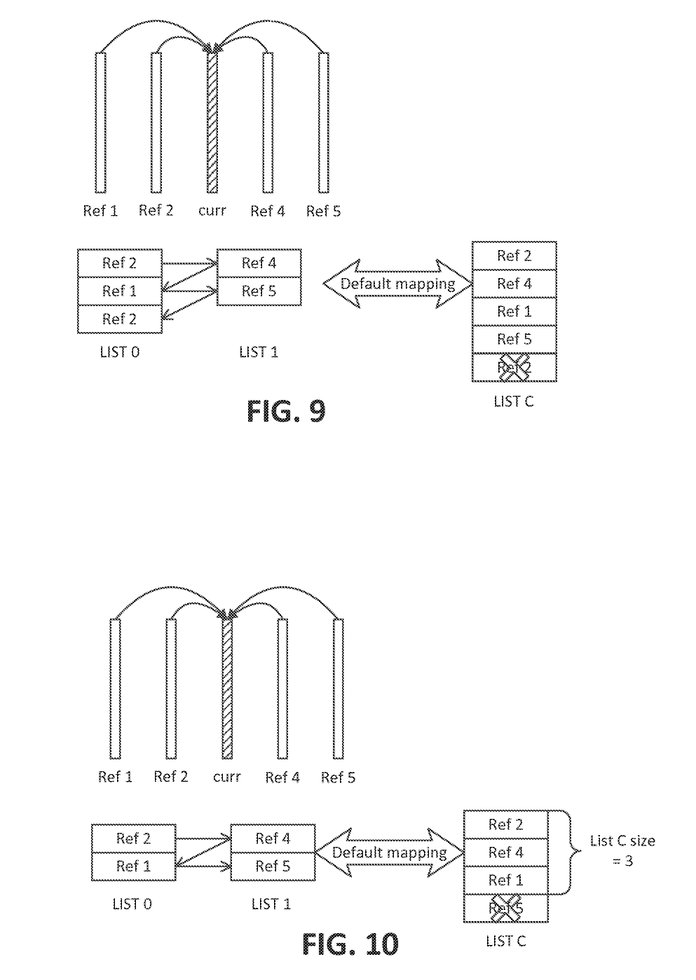

Reference pictures available to predict a current picture may be represented by one or more reference picture lists. For a P picture/slice, the corresponding reference picture list may be relatively simple as blocks may be predicted using uni-prediction. For example, a P picture/slice may correspond to a list. For a B picture/slice, some blocks may be predicted using bi-prediction while others may use uni-prediction. For blocks predicted using bi-prediction, more than one, such as two, reference picture lists, e.g., list 0 (or L0) and list 1 (or L1), may be used. When a block is bi-predicted, reference picture indices, ref_idx_l0 for list 0 and ref_idx_l1 for list 1 may be used. The reference picture indices may identify the reference picture in the respective list from which the bi-prediction signal may be formed (e.g. using equation (2)). For blocks in a B picture/slice that are predicted using uni-prediction, ref_idx_lc may be used to identify from which reference picture in the combined list the uni-prediction signal may be formed. The combined list (or LC) may be formed by combining L0 and L1 together. LC may serve as the reference picture list for the blocks predicted using uni-prediction in a B picture/slice. Because the entries in list 0 and list 1 may be identical to each other, combining the entries from the two lists and including the unique entries may reduce bit overhead related to reference index signaling. FIG. 6 illustrates an exemplary combining of L0 and L1 into LC. As illustrated in FIG. 6, the default LC may be formed by examining the entries in L0 and L1 in alternating manner (e.g., starting with the first entry in L0), and including the unique entries found so far (e.g., ref 2 and ref 4 may be included once). A prediction structure (e.g., low-delay B) may use the combined list, where the entries in L0 and/or L1 may be identical. FIG. 7 illustrates the resulting combined list, which may be identical to L0 and L1. Exemplary syntax elements used to form the combined list are illustrated in Table 1. The indices ref_idx_l0, ref_idx_l1, or ref_idx_lc may be signaled explicitly in the bitstream, or inferred from neighboring blocks.

TABLE 1

| ref_pic_list_combination( ) { | Descriptor |
|---|---|
| if( slice_type = = B ) { | |
| ref_pic_list_combination_flag | u(1) |
| if( ref_pic_list_combination_flag ) { | |
| num_ref_idx_lc_active_minus1 | ue(v) |
| ref_pic_list_modification_flag_lc | u(1) |
| if( ref_pic_list_modification_flag_lc ) | |
| for( i =0; i <= num_ref_idx_lc_active_minus1; | |
| i++ ) { | |
| pic_from_list_0_flag | u(1) |
| if( ( pic_from_list_0_flag && | |
| num_ref_idx_l0_active_minus1 > 0 ) \|\| | |
| ( !pic_from_list_0_flag && | |
| num_ref_idx_l1_active_minus1 > 0 ) | |
| ref_idx_list_curr | ue(v) |
| } | |
| } | |
| } | |
| } | |

There may be partial overlaps among reference lists L0, L1, and/or LC. When signaling WP parameters for each of the entries in these reference picture lists, to minimize redundancy, one set of parameters to each unique reference picture in these lists may be attached. Current WP parameter signaling may not combine with additional scenarios when reference picture reordering is performed to any of these lists (e.g., the default construction process may not be used), which may result in the same reference picture appearing more than once, e.g., in one or more of the lists. This may put undesired constraints on the mapping between reference pictures in the lists and their corresponding WP parameters. For example, this may result in one list inheriting WP parameters from another list, e.g., L0 or L1 may be forced to inherit WP parameters from LC, or vice versa.

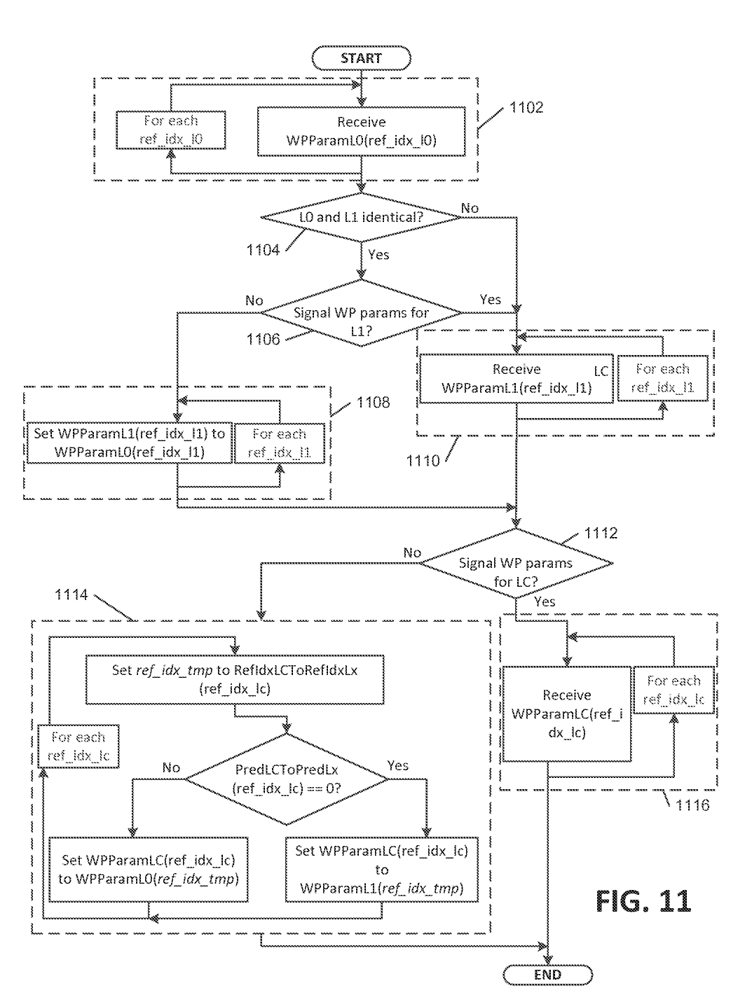

Table 2 illustrates an exemplary syntax table, e.g., for current WP parameter signaling. FIG. 8 illustrates exemplary mapping between reference pictures in one or more of the lists (e.g., L0, L1, and LC) and their associated WP parameters, for a B-coded picture/slice. In case of P-coded picture/slice, there may be one list.

As illustrated in FIG. 8, PredLCToPredLx (ref_idx_lc) may indicate whether the ref_idx_lc is constructed by taking an entry from L0 or from L1. If PredLCToPredLx (ref_idx_lc) is 0, the entry ref_idx_lc may be constructed by taking an entry from L0, otherwise, the entry may be constructed by taking an entry from L1.

RefIdxLCToRefIdxLx (ref_idx_lc) may indicate the value of ref_idx_l0 in L0 or ref_idx_l1 in L1, from which the entry ref_idx_lc may be constructed. If PredLCToPredLx (ref_idx_lc)=0, ref_idx_l0=RefIdxLCToRefIdxLx (ref_idx_lc) may indicate the entry in L0 from which ref_idx_lc may be constructed. If PredLCToPredLx (ref_idx_lc)=1, ref_idx_l1=RefIdxLCToRefIdxLx (ref_idx_lc) may indicate the entry in L1 from which ref_idx_lc may be constructed.

In the example in FIG. 6, PredLCToPredLx ( ) and RefIdxLCToRefIdxLx ( ) may take the following values:
PredLCToPredLx (0)=0, RefIdxLCToRefIdxLx (0)=0 (entry 0 in LC may be constructed from entry 0 in L0)
PredLCToPredLx (1)=1, RefIdxLCToRefIdxLx (1)=0 (entry 1 in LC may be constructed from entry 0 in L1)
PredLCToPredLx (2)=0, RefIdxLCToRefIdxLx (2)=1 (entry 2 in LC may be constructed from entry 1 in L0)
PredLCToPredLx (3)=1, RefIdxLCToRefIdxLx (3)=1 (entry 3 in LC may be constructed from entry 1 in L1)

RefIdxL0/1MappedToRefIdxLC(ref_idx_l0/1) may indicate to which ref_idx_lc in LC the reference index ref_idx_l0 in L0 or ref_idx_l1 in L1 may be mapped. In the example in FIG. 6, RefIdxL0MappedToRefIdxLC( ) and RefIdxL1MappedToRefIdxLC( ) may take the following values:

RefIdxL0MappedToRefIdxLC(0)=0 (entry 0 in L0 is mapped to entry 0 in LC)

RefIdxL0MappedToRefIdxLC(1)=2 (entry 1 in L0 is mapped to entry 2 in LC)

RefIdxL0MappedToRefIdxLC(2)=1 (entry 2 in L0 is mapped to entry 1 in LC)

RefIdxL1MappedToRefIdxLC(0)=1 (entry 0 in L1 is mapped to entry 1 in LC)

RefIdxL1MappedToRefIdxLC(1)=3 (entry 1 in L1 is mapped to entry 3 in LC)

RefIdxL1MappedToRefIdxLC(2)=0 (entry 2 in L1 is mapped to entry 0 in LC)

WPParamLC(ref_idx_lc) may indicate a pair of WP parameters (e.g., weight, offset) for the entry ref_idx_lc in LC, for luma and/or chroma components. WPParamL0/1(ref_idx_l0/1) may indicate the pair of WP parameters (weight, offset) for the entry ref_idx_l0 in L0, or for the entry ref_idx_l1 in L1, for luma and/or chroma components.

FIG. 8 illustrates exemplary WP parameter signaling (e.g., current WP parameter signaling) for L0, L1, and LC. As illustrated in FIG. 8, at 802 a determination may be made whether WP parameters are signaled for L0/L1 or LC. If the WP parameters are signaled for L0 and L1, the branch on the left side may be invoked, and the WP parameters may be signaled and received for the lists L0 and L1 at 806 and 808 respectively. At 810, the WP parameters for LC may be inherited from the corresponding entries in L0 and/or L1 (e.g., depending on mapping of the list indices during the list combination process). If WP parameters are signaled for LC, at 804, the WP parameters for LC may be received. At 812 and 814, the WP parameters for L0 and L1 may be inherited from the corresponding entries in LC respectively (e.g., depending on the mapping during the list combination process). The WP parameters may be assigned to the entries in one or more of the three lists, but the parameters may not be changed independently for each list.

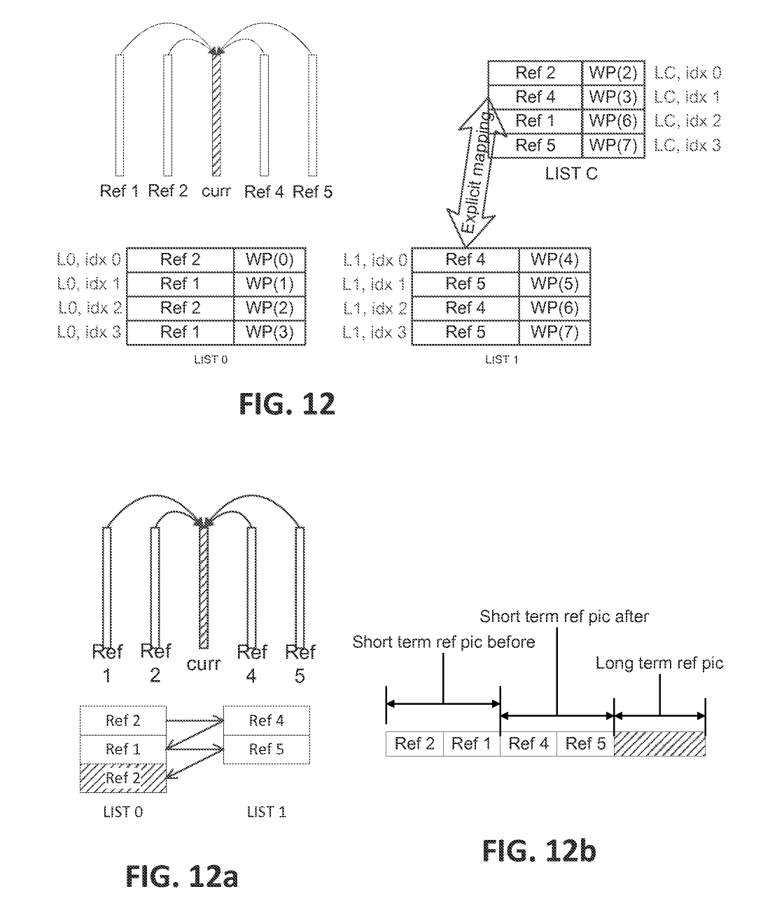

Besides default ways to construct reference picture lists, e.g., L0, L1, and LC, reference picture list reordering or modification may be applied, e.g., to rearrange the entries in the lists. The rearrangements may include one or more of duplicating one or more entries, removing one or more entries, or changing the order of some entries. When reference picture list reordering is applied, with the current constraints, the reordering processes of L0, L1, and LC may be used such that the WP parameters are inherited from the other lists. For example, as illustrated in FIG. 9, after reference picture reordering is performed, entry 0 (“Ref 2”) and entry 2 (“Ref 2”) in the list L0 mayrepresent the same physical picture in the DPB (e.g., the picture “Ref 2”). Such an arrangement may be referred to as reference picture duplication. The arrangement may be used to assign different WP parameters to the same physical reference picture to accommodate local and/or regional illumination changes. In this example, it may be desired to assign WP parameters to each of the entry 0 and entry 2. When the default reference picture combination process is performed, one instance of the same picture may appear in the combined list LC. As illustrated in FIG. 8, at 804, when the branch on the right side is invoked, at 812 and 814, WP parameters may be signaled for LC and assigned to entries in L0 and L1 respectively. The entry 0 and entry 2 in L0 may be forced to share the same WP parameters.

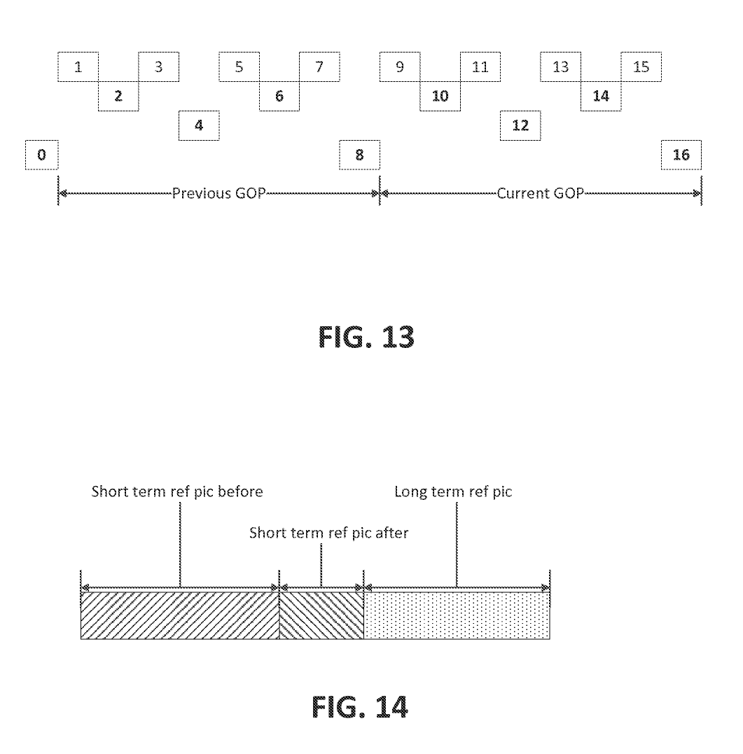

In the example of FIG. 10, the number of entries in the combined list LC (e.g., identified by num_ref_idx_lc_active_minus1 in Table 1) may be smaller than the number of unique pictures contained in L0 and L1. As illustrated in FIG. 8, when the branch on the right of 802 is invoked, at 804, WP parameters may be signaled for LC and assigned to entries in L0 and L1. Since not all entries in L0 and L1 may be found in LC, WP may not be performed for the missing entry (e.g., the reference picture “Ref 5”).

The syntax in Table 2 illustrates that when ref_pic_list_combination_flag is equal to 0, the WP parameters may be signaled for L0 first and for L1 second. For example, as indicated in HEVC CD, when ref_pic_list_combination_flag=0, entries in L0 and L1 may be identical. There may be some inherent redundancy in L0 and L1. Systems, methods, and instrumentalities are described herein that may remove the constraints imposed by the signaling while maintaining low bit overhead associated with WP parameter signaling.

TABLE 2

| pred_weight_table( ) { | Descriptor |
|---|---|
| luma_log2_weight_denom | ue(v) |
| if( chroma_format_idc != 0 ) | |
| delta_chroma_log2_weight_denom | se(v) |
| if( slice_type = = P \|\| | |
| ( slice_type = = | |
| B && ref_pic_list_combination_flag = = | |
| 0 ) ) { | |
| for( i = 0; i <= num_ref_idx_l0_active_minus1; | |
| i++ ) { | |
| luma_weight_l0_flag | u(1) |
| if( luma_weight_l0_flag ) { | |
| delta_luma_weight_l0[ i ] | se(v) |
| luma_offset_l0[ i ] | se(v) |
| } | |
| if( chroma_format_idc != 0 ) { | |
| chroma_weight_l0_flag | u(1) |
| if( chroma_weight_l0_flag ) | |
| for( j =0; j < 2; j++ ) { | |
| delta_chroma_weight_l0[ i ][j ] | se(v) |
| delta_chroma_offset_l0[ i ][j ] | se(v) |
| } | |
| } | |
| } | |
| } | |
| if( slice_type = = B ) { | |
| if( ref_pic_list_combination_flag = = 0 ) { | |
| for( i = 0; 1 <= num_ref_idx_l1_active_minus1; | |
| i++ ) { | |
| luma_weight_l1_flag | u(1) |
| if( luma_weight_l1_flag ) { | |
| delta_luma_weight_l1[ i ] | se(v) |
| luma_offset_l1[ i ] | se(v) |
| } | |
| if( chroma_format_idc != 0 ) { | |
| chroma_weight_l1_flag | u(1) |
| if( chroma_weight_l1_flag ) | |
| for( j = 0; j < 2; j++ ) { | |
| delta_chroma_weight_l1[ i ][ j ] | se(v) |
| delta_chroma_offset_l1[ i ][ j ] | se(v) |
| } | |
| } | |
| } | |
| } else { | |
| for( i = 0; i <= num_ref_idx_lc_active_minus1; | |
| i++ ) { | |
| luma_weight_lc_flag | u(1) |
| if( luma_weight_l1_flag ) { | |
| delta_luma_weight_lc[ i ] | se(v) |
| luma_offset_lc[ i ] | se(v) |
| } | |
| if( chroma_format_idc != 0 ) { | |
| chroma_weight_lc_flag | u(1) |
| if( chroma_weight_lc_flag ) | |
| for( j = 0; j < 2; j++ ) { | |
| delta_chroma_weight_lc[ i ][ j ] | se(v) |
| delta_chroma_offset_lc[ i ][ j ] | se(v) |
| } | |
| } | |
| } | |
| } | |
| } | |
| } | |

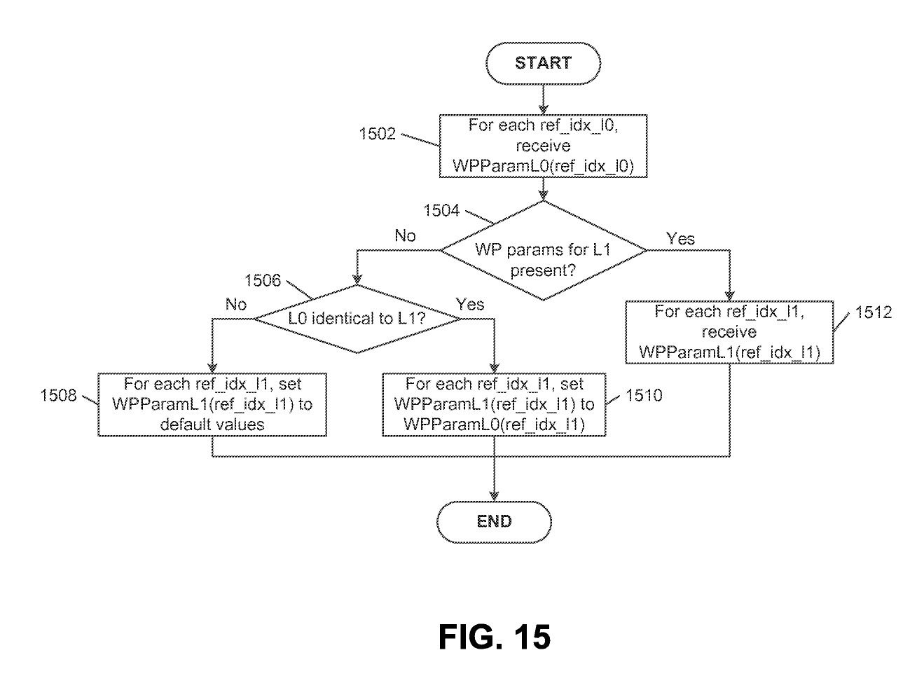

WP parameter signaling may permit WP parameters to be signaled for L0, L0 and L1, or L0, L1, and LC lists. WP parameter prediction may be disclosed to reduce signaling overhead. WP parameter signaling may be used to remove the constraints (e.g., because of forcing L0/L1 to inherit the WP parameters from LC, or vice versa). FIG. 11 illustrates exemplary WP parameter signaling. An associated syntax table is illustrated in Table 3. At 1102, the WP parameters for L0 may be signaled (e.g., for P and B slices). A weights present flag may be used to indicate whether WP parameters are signaled for a list (e.g., based on condition(s)). For example, at 1104 a determination may be made whether L1 is identical to L0. If L1 is identical to L0, a flag (e.g., weights_l1_present_flag), may be sent to indicate whether WP parameters for L1 may be signaled. If L1 is not identical to L0, weights_l1_present_flag may be set to 1. If L0 is not identical to L1 or the weights_l1_present_flag is equal to 1, at 1110 WP parameters may be explicitly signaled for each entry in L1. Otherwise, no additional L1 parameters may be signaled, and at 1108, the L1 parameters may be copied from corresponding entries in L0. For LC, a flag (e.g., weights_lc_present_flag) may be sent to indicate if WP parameters for LC may be signaled explicitly or inherited from the corresponding entries in L0 and L1. At 1112, the weights_lc_present_flag may be checked. If weights_lc_present_flag is equal to 1 (or LC parameters are signaled), at 1116, WP parameters may be explicitly signaled for each entry in LC. If weights_lc_present_flag is equal to 0, at 1114, for each entry in LC, PredLCToPredLx( ) and RefIdxLCToRefIdxLx( ) may be used to identify the originating entry in L0 or L1, and the corresponding WP parameters of that originating entry may be copied to the current LC entry.

WP parameters of L1 may be inherited from L0 and/or signaled separately. When L0 and L1 are identical, different WP parameters assigning different WP parameters may improve the prediction precision for bi-prediction. For example, because the weights may have fixed precision, w_log 2_denom, the weights in L1, w₁=w₀+1 or w₁=w₀−1 may be allowed to improve the fixed-point precision arithmetic as provided in equation (6). The same may be true for the offsets have integer precision. The encoder may decide the optimal WP parameters for each prediction type.

WP parameters of LC may be inherited from L0/L1 or signaled separately. The reference pictures in LC and their weights/offsets may be used for uni-prediction (e.g., equation (5) may be applied), whereas the reference pictures and their weights/offsets in L0 and L1 may be used for bi-prediction (e.g., equation (6) may be applied). The encoder may be given the flexibility to decide the optimal WP parameters for each prediction type.

TABLE 3

| pred_weight_table( ) { | Descriptor |
|---|---|
| luma_Jog2_weight_denom | ue(v) |
| if( chroma_format_idc != 0 ) | |
| delta_chroma_log2_weight_denom | se(v) |
| for( i = 0; i <= num_ref_idx_l0_active_minus1; | |
| i++ ) { | |
| luma_weight_l0_flag | u(1) |
| if( luma_weight_l0_flag ) { | |
| delta_luma_weight_l0[ i ] | se(v) |
| delta_luma_offset_l0[ i ] | se(v) |
| } | |
| if( chroma_format_idc != 0 ) { | |
| chroma_weight_l0_flag | u(1) |
| if( chroma_weight_l0_flag ) | |
| for( j =0; j < 2; j++ ) { | |
| delta_chroma_weight_l0[ i ][ j ] | se(v) |
| delta_chroma_offset_l0[ i ][ j ] | se(v) |
| } | |
| } | |
| } | |
| if( slice_type = = B ) { | |
| if( ref_pic_list_combination_flag = = 0 ) // L0 and | |
| L1 are identical | |
| weights_l1_present_flag | u(1) |
| if(_l1_present_flag) { | |
| for( i = 0; i <= num_ref_idx_l1_active_minus1; | |
| i++ ) { | |
| luma_weight_l1_flag | u(1) |
| if( luma_weight_l1_flag) { | |
| delta_luma_weight_l1[ i ] | se(v) |
| delta_luma_offset_l1[ i ] | se(v) |
| } | |
| if( chroma_format_idc != 0 ) { | |
| chroma_weight_l1_flag | u(1) |
| if( chroma_weight_l1_flag ) | |
| for( j = 0; j < 2; j++ ) { | |
| delta_chroma_weight_l1[ i ][ j ] | se(v) |
| delta_chroma_offset_l1[ i ][ j ] | se(v) |
| } | |
| } | |
| } | |
| } | |
| weights_lc_present_flag | u(1) |
| if( weights_lc_present_flag ) { | |
| for( i = 0; i <= num_ref_idx_lc_active_minus1; | |
| i++ ) { | |
| luma_weight_lc_flag | u(1) |
| if( luma_weight_lc_flag ) { | |
| delta_luma_weight_lc[ i ] | se(v) |
| delta_luma_offset_lc[ i ] | se(v) |
| } | |
| if( chroma_format_idc != 0 ) { | |
| chroma_weight_lc_flag | u(1) |
| if( chroma_weight_lc_flag) | |
| for( j = 0; j < 2; j++ ) { | |
| delta_chroma_weight_lc[ i ][ j ] | se(v) |
| delta_chroma_offset_lc[ i ][ j ] | se(v) |
| } | |
| } | |
| } | |
| } | |
| } | |
| } | |

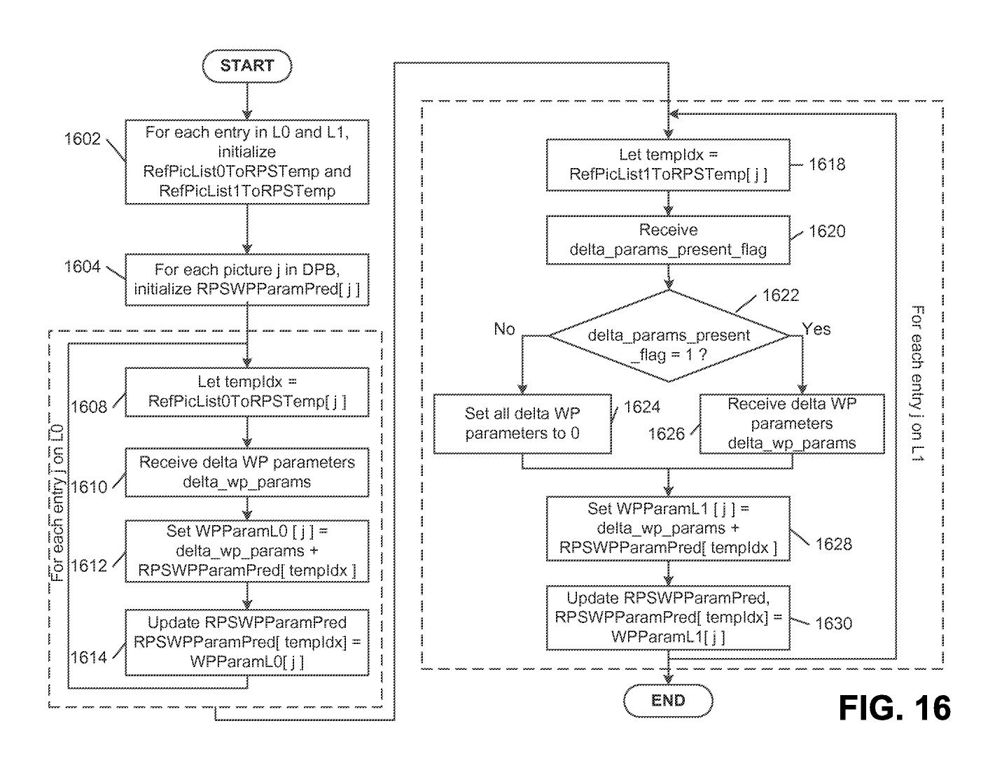

In WP parameter signaling, modifications of the lists L0, L1, and LC may be made such that different WP parameters may be assigned to LC and used for uni-prediction. FIG. 12 illustrates an exemplary reordering process, where the two entries in the lists L0 and L1 may be repeated, and different WP parameters (e.g., WP(0) and WP(2) for “Ref 2”) may be assigned to the repeated entries. The explicit reference picture combination process, achieved by setting ref_pic_list_modification_flag_lc in Table 1 to 1, may be used to form LC. The entries in LC formed this way may carry WP parameters different from those used for bi-prediction. The WP parameter signaling may provide flexibility of bundling the signaling of WP parameters of one or more of the lists L0, L1 and LC together, or signaling each of them separately.

In HEVC coding, the weights and the offsets may be predicted based on different schemes. For the weights of the luma component, delta_luma_weight_l0/l1/lc[i] may be sent (e.g., as illustrated in Table 2). For the i-th reference, for example, in the list L0 or L1 or LC, its weight, LumaWeightL0/L1/LC [i] may be set to:

LumaWeightLx[i]=(1<<luma_log 2_weight_denom)+delta_luma_weight_{—}lx[i]

The weights of the chroma components may be predicted similarly. For example, for the i-th reference in the list L0 or L1 or LC, the weight of the j-th chroma component (j=0 or 1), ChromaWeightL0/L1/LC [i][j] may be set to:

ChromaWeightLx[i][j]=(1<<chroma_log 2_weight_denom)+delta_chroma_weight_{—}lx[i][j]

The offsets of the luma component may be sent directly and set as:

LumaOffsetLx[i]=luma_offset_{—}lx[i]

The offsets of the chroma components may be predicted as:

ChromaOffsetLx[i][j]=(ChromaOffsetPredLx[i][j]+delta_chroma_offset_{—}lx[i][i])

ChromaOffsetPredLx[i][j]=shift−((shift*ChromaWeightLx[i][j])>>ChromaLog 2WeightDenom)

where shift=1<<(BitDepth_{C}−1) and BitDepth_{C} is the bit-depth of the chroma components.

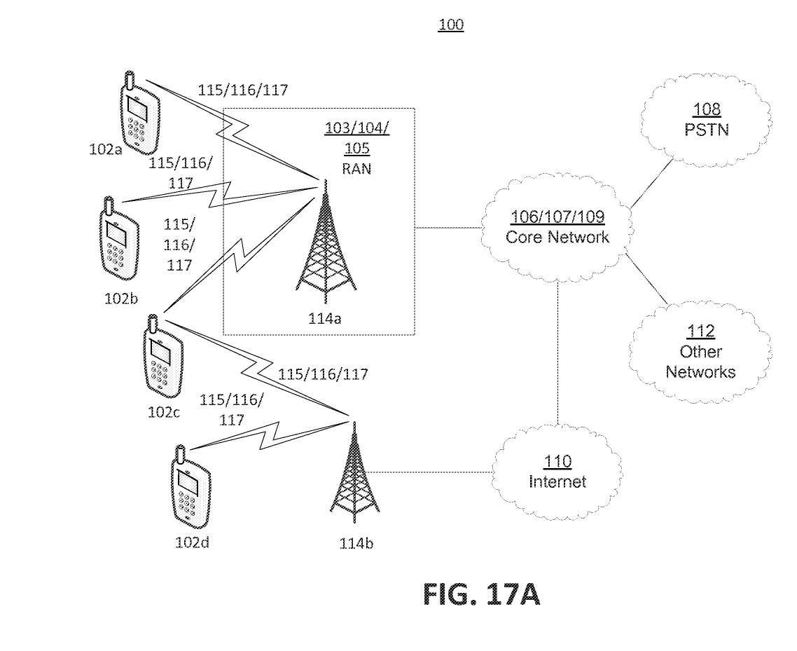

In video coding standards, e.g., H.264/AVC and HEVC, the entries in L0 and L1 may have overlaps with each other. FIG. 13 illustrates an exemplary prediction structure used in the random access setting in HEVC common testing conditions. FIG. 13 illustrates previous group of pictures (GOP) with POC from 1 to 8, and current group of pictures with POC 9 to 16. Table 4 provides the composition of the lists L0, L1, and LC for each picture in a GOP. As illustrated in Table 4 and FIG. 13, the four pictures in the GOP (e.g., with POC=12, 9, 14, 15) may have common entries in L0 and L1. For the combined list LC, LC may be a virtual list mapped from entries in L0 and L1.

TABLE 4

Reference picture lists

| POC | L0 | L1 | LC |
|---|---|---|---|
| 16 | {8, 6, 4, 0} | {8, 6, 4, 0} | {8, 6, 4, 0} |
| 12 | {8, 6} | {16, 8} | {8, 16, 6) |
| 10 | {8, 6} | {12, 16} | {8, 12, 6, 16} |
| 9 | {8, 10} | {10, 12} | {8, 10, 12} |
| 11 | {10, 8} | {12, 16} | {10, 12, 8, 16} |
| 14 | {12, 10} | {16, 12} | {12, 16, 10} |
| 13 | {12, 8} | {14, 16} | {12, 14, 8, 16} |
| 15 | {14, 12} | {16, 14} | {14, 16, 12} |

If an entry in L1 appears in L0, the values of their WP parameters may be correlated (although not necessarily identical). In such a case, the WP parameters of a particular entry, e.g., in L1 may be predicted based on an already occurred entry, e.g., in L0. If reference picture duplication (for example, as illustrated in FIG. 9) occurs in L0, such that L0 includes a physical reference picture more than once, the WP parameters of the second entry may be predicted from those of the first entry. Similarly, WP parameters within L1 may be predicted. When the prediction value is not available (e.g., when the WP parameter for a given reference picture has not been signaled), other HEVC predictions may be used.

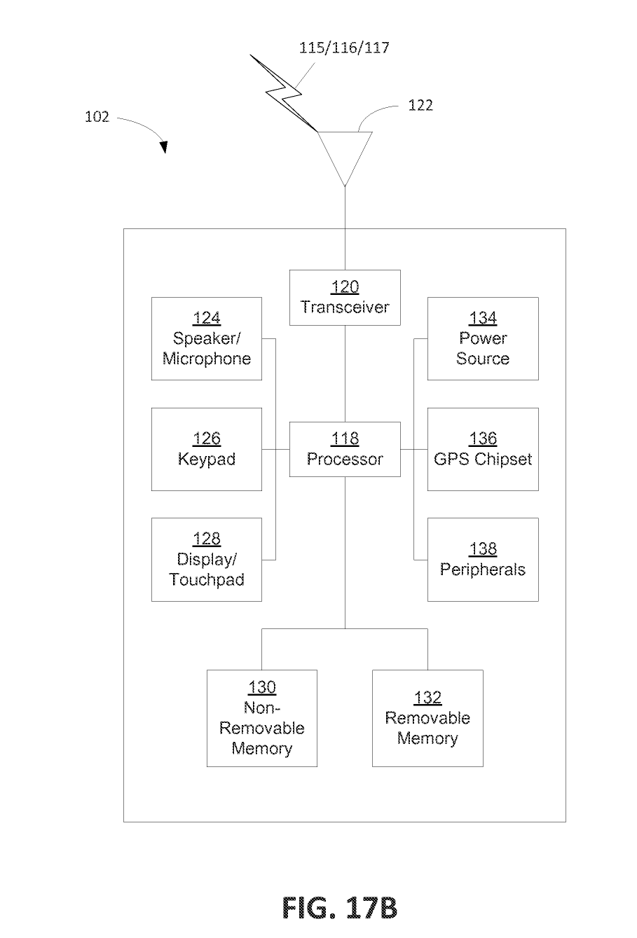

An inherent mapping relationship may be present between the reference picture list indices and the physical reference picture in the DPB. This relationship may be used to identify the entries in the lists L0 and L1 that may refer to the same physical reference picture in the DPB. Such identification may allow to set the WP parameter prediction values such that parameters of the current reference index from those of another reference index that refers to the same physical picture that have been already sent. The arrays RefPicList0ToRPSTemp and RefPicList1ToRPSTemp may be formed using, e.g., the “Pseudo code 1,” to identify the mapping relationship between the reference picture lists and the physical reference pictures in the DPB. The latter may be represented by the array RefPicListTemp0 as illustrated by example in FIG. 14.

Pseudo Code 1:

// construction of RefPicListTemp0
cIdx = 0
while( cIdx < NumRpsCurrTempList0) {
for( i = 0; i < NumPocStCurrBefore && cIdx < NumRpsCurrTempList0; cIdx++, i++ )

RefPicListTemp0[ cIdx ] = RefPicSetStCurrBefore[ i ]

for( i = 0; i < NumPocStCurrAfter && cIdx < NumRpsCurrTempList0; cIdx++, i++

)

RefPicListTemp0[ cIdx ] = RefPicSetStCurrAfter[ i ]

for( i = 0; i < NumPocLtCurr && cIdx < NumRpsCurrTempList0; cIdx++, i++ )

RefPicListTemp0[ cIdx ] = RefPicSetLtCurr[ i ]

}
// construction of RefPicList0ToRPSTemp andRefPicList1ToRPSTemp
for ( cIdx = 0; cIdx ≦ num_ref_idx_l0_active_minus1; cIdx++) {

RefPicList0ToRPSTemp[ cIdx ] = ref_pic_list_modification_flag_l0 ? list_entry_l0[

cIdx ] : cIdx

}
for ( cIdx = 0; cIdx ≦ num_ref_idx_l1_active_minus1; cIdx++) {

```
  tempIdx = ref_pic_list_modification_flag_l0 ? list_entry_l0[ cIdx ] : cIdx
  RefPicList1ToRPSTemp[ cIdx ] = tempIdx < NumPocStCurrAfter ? tempIdx
```

+NumPocStCurrBefore :

tempIdx < NumPocStCurrAfter +

NumPocStCurrBefore ? tempIdx − NumPocStCurrAfter: tempIdx
}

With the arrays RefPicList0ToRPSTemp and RefPicList1ToRPSTemp, e.g., the “Pseudo code 2” may be used to initialize the prediction values for the WP parameters (e.g., luma and chroma weights and offsets), code the WP parameters for each L0 entry, followed by those for each L1 entry, and update the prediction values on the fly.

Pseudo Code 2:

// initialize prediction values for physical reference pictures in DPB

for (cIdx = 0; cIdx < NumPocTotalCurr; cIdx ++ ) {

RPSTempLumaWeightPred [ cIdx ] = (1 << luma_log2_weight_denom )
RPSTempChromaWeightPred [ cIdx ][0] = RPSTempChromaWeightPred

[ cIdx ][1] = (1 << ChromaLog2WeightDenom )

RPSTempLumaOffsetPred [cIdx] = 0
RPSTempChromaOffsetPred[cIdx][ 0 ] = RPSTempChromaOffsetPred[cIdx ][1]

= 0

RPSTempChromaOffsetPredInitialized[ cIdx ] = 0;

}
// for List 0 (L0) WP parameters
for (cIdx = 0; cIdx <= num_ref_idx_list0_active_minus1; cIdx ++ ) {

tempIdx = RefPicList0ToRPSTemp[ cIdx]
LumaWeightL0[ cIdx ] = RPSTempLumaWeightPred[ tempIdx ] +

delta_luma_weight_l0[ cIdx ]

LumaOffsetL0[ cIdx ] = RPSTempLumaOffsetPred[ tempIdx ] +

delta_luma_offset_l0[ cIdx ]

ChromaWeightL0[ cIdx ][ 0 ] = RPSTempChromaWeightPred[ tempIdx ][ 0 ] +

delta_chroma_weight_l0[ cIdx ][ 0 ]

ChromaWeightL0[ cIdx ][ 1 ] = RPSTempChromaWeightPred[ tempIdx ][ 1 ] +

delta_chroma_weight_l0[ cIdx ][ 1 ]

if ( RPSTempChormaOffsetPredInitialized[ tempIdx ] = = 0 ) {

RPSTempChromaOffsetPred[tempIdx][0] = shift −

( (shift*ChromaWeightL0[ cIdx ][ 0 ]) >> ChromaLog2WeightDenom )

RPSTempChromaOffsetPred[tempIdx][1] = shift −

( (shift*ChromaWeightL0[ cIdx ][ 1 ]) >> ChromaLog2WeightDenom )

RPSTempChromaOffsetPredInitialized[ cIdx ] = 1

}
ChromaOffsetL0[ cIdx ][ 0 ] = RPSTempChromaOffsetPred[tempIdx][0] +

delta_chroma_offset_l0[ cIdx ][ 0 ]

ChromaOffsetL0[ cIdx ][ 1 ] = RPSTempChromaOffsetPred[tempIdx][1] +

delta_chroma_offset_l0[ cIdx ][ 1 ]

// update WP parameter predictions in RPS
RPSTempLumaWeightPred [ tempIdx ] = LumaWeightL0[ cIdx ]
RPSTempLumaOffsetPred [tempIdx] = LumaOffsetL0[ cIdx ]
RPSTempChromaWeightPred [ tempIdx ][0] = ChromaWeightL0 [ cIdx ][0]
RPSTempChromaWeightPred [ tempIdx ][1] = ChromaWeightL0 [ cIdx ][1]
RPSTempChromaOffsetPred[tempIdx][ 0 ] = ChromaOffsetL0[ cIdx ][0]
RPSTempChromaOffsetPred[tempIdx][ 1 ] = ChromaOffsetL0[ cIdx ][1]

}
// for List 1 (L1) WP parameters
if ( weights_l1_present_flag = = 1) (

for (cIdx = 0; cIdx <= num_ref_idx_list1_active_minus1; cIdx ++ ) {

tempIdx = RefPicList1ToRPSTemp[ cIdx]
LumaWeightL1[ cIdx ] = RPSTempLumaWeightPred[ tempIdx ] +

delta_luma_weight_l1[ cIdx ]

LumaOffsetL1[ cIdx ] = RPSTempLumaOffsetPred[ tempIdx ] +

delta_luma_offset_l1[cIdx]

ChromaWeightL1[ cIdx ][ 0 ] = RPSTempChromaWeightPred[ tempIdx ][ 0 ] +

delta_chroma_weight_l1[ cIdx ][ 0 ]

ChromaWeightL1[ cIdx ][ 1 ] = RPSTempChromaWeightPred[ tempIdx ][ 1 ] +

delta_chroma_weight_l1[ cIdx ][ 1 ]

if( RPSTempChormaOffsetPredInitialized[ tempIdx ] = = 0 ) {

RPSTempChromaOffsetPred[tempIdx][0] = shift −

( (shift*ChromaWeightL1[ cIdx ][ 0 ]) >> ChromaLog2WeightDenom )

RPSTempChromaOffsetPred[tempIdx][1] = shift −

( (shift*ChromaWeightL1[ cIdx ][ 1 ]) >> ChromaLog2WeightDenom )

RPSTempChromaOffsetPredInitialized[ cIdx ] = 1

}
ChromaOffsetL1[ cIdx ][ 0 ] = RPSTempChromaOffsetPred[tempIdx][0] +

delta_chroma_offset_l1[ cIdx ][ 0 ]

ChromaOffsetL1[ cIdx ][ 1 ] = RPSTempChromaOffsetPred[tempIdx][1] +

delta_chroma_offset_l1[ cIdx ][ 1 ]

// update WP parameter predictions in RPS
RPSTempLumaWeightPred [ tempIdx ] = LumaWeightL1[ cIdx ]
RPSTempLumaOffsetPred [tempIdx] = LumaOffsetL1[ cIdx ]
RPSTempChromaWeightPred [ tempIdx ][0] = ChromaWeightL1 [ cIdx ][0]
RPSTempChromaWeightPred [ tempIdx ][1] = ChromaWeightL1 [ cIdx ][1]
RPSTempChromaOffsetPred[tempIdx][ 0 ] = ChromaOffsetL1[ cIdx ][0]
RPSTempChromaOffsetPred[tempIdx][ 1 ] = ChromaOffsetL1[ cIdx ][1]

}

} else { // L1 identical to L0 and uses the same WP parameters

for (cIdx = 0; cIdx <= num_ref_idx_list1_active_minus1; cIdx ++ ) {

LumaWeightL1[ cIdx ] = LumaWeightL0[ cIdx ]
LumaOffsetL1[ cIdx ] = LumaOffsetL0[ cIdx ]
ChromaWeightL1[ cIdx ][ 0 ] = ChromaWeightL0[ cIdx ][ 0 ]
ChromaWeightL1[ cIdx ][ 1 ] = ChromaWeightL0[ cIdx ][ 1 ]
ChromaOffsetL1[ cIdx ][ 0 ] = ChromaOffsetL0[ cIdx ][ 0 ]
ChromaOffsetL1[ cIdx ][ 1 ] = ChromaOffsetL0[ cIdx ][ 1 ]

}

}

For the combined list LC, one or more entries in LC may be mapped from L0 or L1, and this mapping relationship may be specified by PredLCToPredLx (ref_idx_lc) and RefIdxLCToRefIdxLx (ref_idx_lc). The WP parameters of each entry ref_idx_lc in LC may be predicted from the corresponding entry in L0 or in L1. For example, “Pseudo code 3” summarizes how the weights and offsets for luma and for chroma may be derived using the syntax table shown in Table 3.

Pseudo Code 3:

// for the combined list LC

for (cIdx = 0; cIdx < num_ref_idx_listc_active_minus1; cIdx++ ) {

if ( PredLCToPredLx [ cIdx ] == 0 ) {
LumaWeightPred = LumaWeightL0[RefIdxLCToRefIdxLx [ cIdx ]]
LumaOffsetPred = LumaWeightL0[RefIdxLCToRefIdxLx [ cIdx ]]
ChromaWeightPred[0] = ChromaWeightL0[RefIdxLCToRefIdxLx [ cIdx ]][ 0 ]
ChromaOffsetPred[0] = ChromaOffsetL0[RefIdxLCToRefIdxLx [ cIdx ]][ 0 ]
ChromaWeightPred[1] = ChromaWeightL0[RefIdxLCToRefIdxLx [ cIdx ]][ 1 ]
ChromaOffsetPred[1] = ChromaOffsetL0[RefIdxLCToRefIdxLx [ cIdx ]][ 1 ]
} else {

LumaWeightPred = LumaWeightL1[RefIdxLCToRefIdxLx [ cIdx ]]

| LumaOffsetPred = LumaWeightL1[RefIdxLCToRefIdxLx [ cIdx ]] | |
|---|---|
| ChromaWeightPred[0] = ChromaWeightL1[RefIdxLCToRefIdxLx [ cIdx ]][ 0 ] | |
| ChromaOffsetPred[0] = ChromaOffsetL1[RefIdxLCToRefIdxLx [ cIdx ]][ 0 ] | |
| ChromaWeightPred[1] = ChromaWeightL1[RefIdxLCToRefIdxLx [ cIdx ]][ 1 ] | |
| ChromaOffsetPred[1] = ChromaOffsetL1[RefIdxLCToRefIdxLx [ cIdx ]][ 1 ] | |
| } | |
| if (weights_lc_present_flag ) { | // the LC carries its own WP parameters |

LumaWeightLC[ cIdx ] = LumaWeightPred +

delta_luma_weight_lc[ cIdx ]

LumaOffsetLC[ cIdx ] = LumaOffsetPred + delta_luma_offset_lc[ cIdx ]
ChromaWeightLC[ cIdx ][ 0 ] = ChromaWeightPred[ 0 ] +

delta_chroma_weight_lc[ cIdx ][ 0 ]

ChromaOffsetLC[ cIdx ][ 0 ] = ChromaOffsetPred[ 0 ] +

delta_chroma_offset_lc[ cIdx ][ 0 ]

ChromaWeightLC[ cIdx ][ 1 ] = ChromaWeightPred[ 1 ] +

delta_chroma_weight_lc[ cIdx ][ 1 ]

ChromaOffsetLC[ cIdx ][ 1 ] = ChromaOffsetPred[ 1 ] +

delta_chroma_offset_lc[ cIdx ][ 1 ]

| | |
|---|---|
| } else { // | the LC inherits WP parameters directly from L0/L1 |

LumaWeightLC[ cIdx ] = LumaWeightPred
LumaOffsetLC[ cIdx ] = LumaOffsetPred
ChromaWeightLC[ cIdx ][ 0 ] = ChromaWeightPred[ 0 ]
ChromaOffsetLC[ cIdx ][ 0 ] = ChromaOffsetPred[ 0 ]
ChromaWeightLC[ cIdx ][ 1 ] = ChromaWeightPred[ 1 ]
ChromaOffsetLC[ cIdx ][ 1 ] = ChromaOffsetPred[ 1 ]

}

}

By predicting the WP parameters of a given reference picture in L0, L1 or LC from the previously sent parameters for another reference picture in L0, L1, or LC that may represent the same physical reference picture, signaling overhead may be reduced while design flexibility is retained, allowing the encoder to optimize the WP parameters. The WP parameters to be signaled may have the same values as its prediction values (e.g., the values stored in LumaWeightPred, LumaOffsetPred, ChromaWeightPred and ChromaOffsetPred), signaling of one set of WP parameters may cost 6 bits (e.g., 1 bit each for 1 delta_luma_weight, 1 bit for delta_luma_offset, 2 bits for delta_chroma_weight, and 2 bits for delta_chroma_offset). An additional flag may be added to indicate that the six values are the same as its prediction. Using such a flag, may reduce the overhead.

Prediction may be added to the syntax elements such as luma/chroma_weight_l1_flag, luma.chroma_offset_l1_flag, luma/chroma_weight_lc_flag, and luma/chroma_offset_lc_flag.

As described herein, when a block is bi-predicted, two reference picture indices, such as ref_idx_l0 for list 0 and ref_idx_l1 for list 1, may be used to identify from which reference picture in the respective list the bi-prediction signal is formed (for example, using equation (2)). For blocks in a B picture/slice that are predicted using uni-prediction, the list “lx” from which the block is predicted may be signaled. The reference index ref_idx_lx in that given list may be signaled. A combined list (LC) may signal the reference index for uni-prediction blocks. In another embodiment, the LC may not be signaled, for example, when the LC does not provide substantial performance benefits.

In a B-coded picture/slice, entries on the reference lists L0 and L1 may be associated with the same physical picture in the decoded picture buffer. When reference picture duplication is used, two or more entries on the same list may be associated with the same physical picture in the DPB. The WP parameters associated with these entries may be highly correlated (that is, they take the same values or very similar values). The WP parameter signaling may rely on the LC to signal WP parameters, e.g., to minimize signaling redundancy. WP parameter signaling may be minimized without relying on the LC to signal WP parameters.

As described herein, temporal prediction structures may have overlaps between entries on L0 and L1. For example, L0 and L1 may be identical in the low-delay setting in the HEVC common test conditions for B pictures. For the random access setting, the hierarchical B prediction structure illustrated in FIG. 13 may be used. The reference picture lists used to code a picture are illustrated in Table 5, where the repeated entries on L0 and L1 are underlined. As illustrated in the exemplary Table 5, repeated entries in the lists L0 and L1 may occur roughly half of the time.

TABLE 5

Reference picture lists

| POC | L0 | L1 |
|---|---|---|
| 16 | {8, 6, 4, 0} | {8, 6, 4, 0} |
| 12 | {8, 6} | {16, 8} |
| 10 | {8, 6} | {12, 16} |
| 9 | {8, 10} | {10, 12} |
| 11 | {10, 8} | {12, 16} |
| 14 | {12, 10} | {16, 12} |
| 13 | {12, 8} | {14, 16} |
| 15 | {14, 12} | {16, 14} |

A syntax table for WP parameter signaling may be used. When there are repeated entries between L0 and L1 or in the same list (e.g., if reference picture duplication is used), and these repeated entries have correlated WP parameters, signaling redundancy, e.g., using Table 6, may be high.

TABLE 6

| pred_weight_table( ) { | Descriptor |
|---|---|
| luma_log2_weight_denom | ue(v) |
| if( chroma_format_idc != 0 ) | |
| delta_chroma_log2_weight_denom | se(v) |
| if( slice_type = = P \|\| slice_type = = B ) { | |
| for( i = 0; i <= num_ref_idx_l0_active_minus1; | |
| i++ ) { | |
| luma_weight_l0_flag | u(1) |
| if( luma_weight_l0_flag ) { | |
| delta_luma_weight_l0[ i ] | se(v) |
| luma_offset_l0[ i ] | se(v) |
| } | |
| if( chroma_format_idc != 0 ) { | |
| chroma_weight_l0_flag | u(1) |
| if( chroma_weight_l0_flag ) | |
| for( j =0; j < 2; j++ ) { | |
| delta_chroma_weight_l0[ i ][ j ] | se(v) |
| delta_chroma_offset_l0[ i ][ j ] | se(v) |
| } | |
| } | |
| } | |
| } | |
| if( slice_type = = B ) { | |
| for( i = 0; i <= num_ref_idx_l1_active_minus1; | |
| i++ ) { | |
| luma_weight_l1_flag | u(1) |
| if( luma_weight_l1_flag ) { | |
| delta_luma_weight_l1[ i ] | se(v) |
| luma_offset_l1[ i ] | se(v) |
| } | |
| if( chroma_format_idc != 0 ) { | |
| chroma_weight_l1_flag | u(1) |
| if( chroma_weight_l1_flag ) | |
| for( j = 0; j < 2; j++) { | |
| delta_chroma_weight_l1[ i ][ j ] | se(v) |
| delta_chroma_offset_l1[ i ][ j ] | se(v) |
| } | |
| } | |
| } | |
| } | |

The weights and the offsets for a reference picture list entry may be predicted based on different schemes. As illustrated in Table 6, for the weights of the luma component, delta_luma_weight_l0/l1[i] may be sent. The luma weight for the i-th reference in the list L0 or L1, LumaWeightL0/L1 [i], may be set to:

LumaWeightLx[i]=(1<<luma_log 2_weight_denom)+delta_luma_weight_{—}lx[i].

The weights of the chroma components may be predicted similarly. For example, for the i-th reference in the list L0 or L1, the weights of the two chroma components, ChromaWeightL0/L1 [i][j] (j=0 or 1), may be set to

ChromaWeightLx[i][j]=(1<<chroma_log 2_weight_denom)+delta_chroma_weight_{—}lx[i][j].

The offsets of the luma component may or may not be predicted. For example, the offsets may be sent as shown in Table 6 and may be set as follows:

LumaOffsetLx[i]=luma_offset_{—}lx[i].

The offsets of the chroma components may be predicted as follows:

ChromaOffsetLx[ i ][ j ] = (ChromaOffsetPredLx[ i ][ j ] +
delta_chroma_offset_lx[i][j] ),
ChromaOffsetPredLx[ i ][ j ] = shift −

( (shift*ChromaWeightLx[ i ][ j ]) >> ChromaLog2WeightDenom ),

where shift=1<<(BitDepthC−1) and BitDepth_{C} may represent the bit-depth of the chroma components. The prediction schemes of the WP parameters may be further improved and unified.

Signaling overhead may be reduced by performing WP parameter prediction. For example, a flag may indicate whether WP parameters are signaled for L1 entries. A flag for each L1 entry may indicate whether WP parameters are signaled for each L1 entry. WP parameters may be predicted for an entry in L0 and L1 lists based on previously signaled WP parameters for the last reference list entry representing the same physical reference picture in DPB.

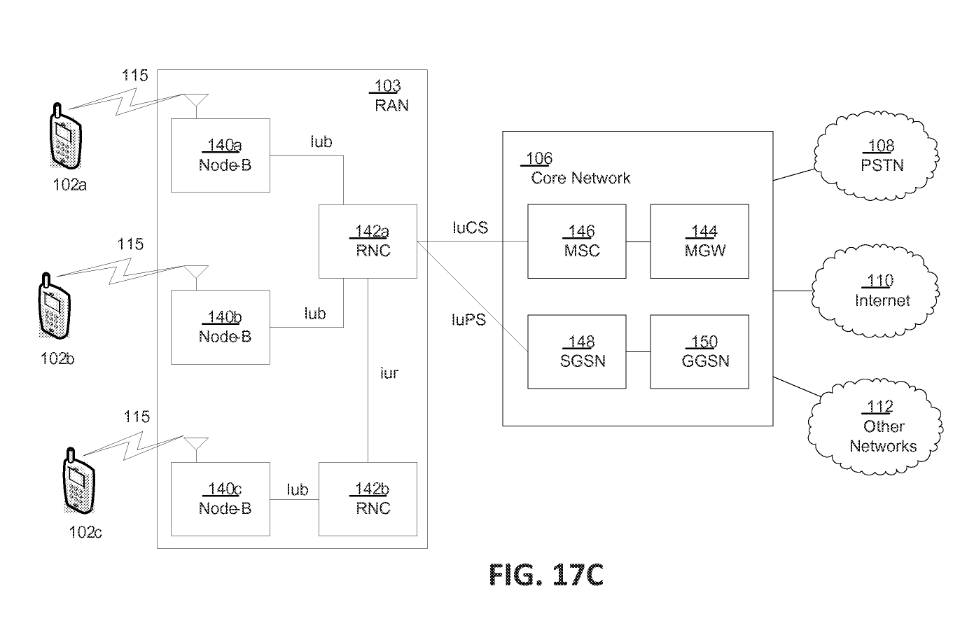

FIG. 15 illustrates an exemplary flow chart for WP parameter signaling. At 1502, the WP parameters for L0 may be signaled (e.g., for P and B slices). For L1, a flag, such as weights_l1_present_flag shown in Table 7, may be sent to indicate whether WP parameters for L1 are signaled, e.g., in the bitstream. For example, when WP parameters for an entry in L1 are signaled, the flag weights_l1_present_flag may be set to 1. At 1504, the flag weights_l1_present flag may be checked. If the flag weight_l1_present flag is set to 1, WP parameters for L1 may be received at 1512. If the flag weight_l1_present_flag is set to 0, WP parameters may not be signaled, and, the WP parameters may be inferred (e.g., determined) at the decoder. For example, if L1 entries are identical to L0 entries, for an entry ref_idx_l1, at 1510, the corresponding WP parameters may be copied from the WP parameters of corresponding L0 entry with ref_idx_l0 equal to ref_idx_l1. If one or more L1 entries differ from the corresponding L0 entries, at 1508, WP parameters for the L1 entries may be set to default values, e.g., using the following “Pseudo code 4”.

Pseudo code 4:

for( i = 0; i < num_ref_idx_l1_active; i++)
{

LumaWeightL1 [ i ] = (1 << luma_log2_weight_denom )
ChromaWeightL1 [ i ][ 0 ] = (1 << chroma_log2_weight_denom )
ChromaWeightL1 [ i ][ 1 ] = (1 << chroma_log2_weight_denom )
LumaOffsetL1 [i] = 0
ChromaOffsetL1[ i ] [ 0 ] = 0
ChromaOffsetL1[ I ] [ 1 ] = 0

}

Whether L0 and L1 are identical may be determined. For example, L1 may be determined identical to L0 when L1 has the same size as L0 (e.g., when num_ref_idx_l1_active is equal to num_ref_idx_l0_active), and/or when an entry on L0 corresponds to an entry on L1 (e.g., denoting the i-th entry on L0 and on L1 as L0 (i) and L1(i), respectively, where L0 (i) and L1(i) refer to the same reference picture in the DPB, e.g., POC of L0 (i) and POC of L1(i) are the same).

Table 7 illustrates an exemplary syntax structure for WP parameter signaling. In Table 7, when weights_l1_present_flag is set to 1, WP parameters for L1 entries may be signaled. As shown in Table 7, signaling of weights_l1_present_flag may depend on whether L1 has the same size as L0.

TABLE 7

| pred_weight_table( ) { | Descriptor |
|---|---|
| luma_log2_weight_denom | ue(v) |
| if( chroma_format_idc != 0 ) | |
| delta_chroma_log2_weight_denom | se(v) |
| for( i = 0; i <= num_ref_idx_l0_active_minus1; | |
| i++ ) { | |
| luma_weight_l0_flag | u(1) |
| if( luma_weight_l0_flag ) { | |
| delta_luma_weight_l0[ i ] | se(v) |
| delta_luma_offset_l0[ i ] | se(v) |
| } | |
| if( chroma_format_idc != 0 ) { | |
| chroma_weight_l0_flag | u(1) |
| if( chroma_weight_l0_flag ) | |
| for( j =0; j < 2; j++ ) { | |
| delta_chroma_weight_l0[ i ][ j ] | se(v) |
| delta_chroma_offset_l0[ i ][ j ] | se(v) |
| } | |
| } | |
| } | |
| if( slice_type = = B ) { | |
| if( num_ref_idx_l0_active_minus1 == | |
| num_ref_idx_l1_active_minus1 ) | |
| weights_l1_present_flag | u(1) |
| if(weights_l1_present_flag) { | |
| for( i = 0; i <= num_ref_idx_l1_active_minus1; | |
| i++ ) { | |
| delta_params_present_flag | |
| if(delta_params_present_flag) { | |
| luma_weight_l1_flag | u(1) |
| if( luma_weight_l1_flag) { | |
| delta_luma_weight_l1[ i ] | se(v) |
| delta_luma_offset_l1[ i ] | se(v) |
| } | |
| if( chroma_format_idc != 0 ) { | |
| chroma_weight_l1_flag | u(1) |
| if( chroma_weight_l1_flag ) | |
| for( j = 0; j < 2; j++ ) { | |
| delta_chroma_weight_l1[ i ][ j ] | se(v) |
| delta_chroma_offset_l1[ i ][ j ] | se(v) |
| } | |
| } | |
| } | |
| } | |
| } | |
| } | |
| } | |

Signaling of weights_l1_present_flag may be based on whether L1 has the same size as L0, and/or whether POC of L0 (i) and POC of L1(i) for each i-th entry on L0 and L1 are the same. This may reduce bit overhead and may be suitable for applications that may accommodate interruption of slice header parsing. For example, when L1 has the same size as L0 and POC of L0 (i) and POC of L1(i) are the same, a flag such as the L0L1 IdenticalFlag may be set to 1. The weights_l1_present_flag may be signaled if the flag L0L1 IdenticalFlag is set to 1. The corresponding syntax structure may include:

....
if (L0L1IdenticalFlag)

weights_l1_present_flag

In an embodiment, the flag weights_l1_present_flag may be signaled regardless of whether L0 and L1 are identical (e.g., the flag value may indicate that WP parameters relating to a first list are to be used for a second list, the flag value may indicate that WP parameters relating to a first list are not to be used for a second list, etc.). The encoder may set the value for the flag. For example, if it is desirable to perform weighted prediction on the reference pictures in L0 and to perform normal non-weighted motion compensated prediction on the reference pictures in L1, the encoder may set weights_l1_present_flag to 0. A flag weights_l0_present_flag may be included in the syntax (e.g., in Table 7), and may be used to collectively skip sending WP parameters for the entries in L0.

As illustrated in Table 5, for hierarchical B prediction structure, for some pictures, one or more entries in L0 and L1 may overlap with each other, but the lists themselves may not be identical. The WP parameters for the overlapping entries may be correlated (e.g., highly correlated). For example, if a particular entry in L1 has appeared in L0, the values of its WP parameters may be identical or similar to those already signaled. Reference picture duplication may be supported by using reference picture reordering.

As illustrated by example in FIG. 12a, when reference picture duplication is used, the physical reference picture in the DPB (e.g., “Ref 2”) may be repeated in the same list (e.g., L0) and may be assigned two or more reference indexes (e.g., entries 0 and 2 of L0). Used in combination with weighted prediction, reference picture duplication may provide the capability to assign two or more sets of WP parameters to the same physical reference picture in the DPB. Efficient compression may be achieved when there are local illumination changes in the pictures. For example, more than one set of WP parameters may be used such that illumination changes in different parts of the picture may be efficiently represented.

The WP parameters of the subsequent entries may be predicted from those of the earlier entries, for example, in case of overlapping reference picture entries in L0 and L1 and/or reference picture duplication in the same list. When the prediction values are not available (e.g., the WP parameters for a given reference picture have not been signaled yet), the prediction values may be set to the default values (e.g., 0) as in “Pseudo code 4,” or to predetermined values. The syntax elements in the WP signaling (e.g., the elements shown in Table 7) may be sent as delta values between the prediction values and the actual values.

There may be a mapping between the reference picture list indices and the physical reference pictures in the DPB. This relationship may be used to quickly identify which entries in lists L0 and L1 that may refer to the same physical reference picture in the DPB. The identification may allow setting the WP parameter prediction values such that the parameters of the current reference index may be predicted from the reference index sent earlier that may refer to the same physical picture. The arrays RefPicList0ToRPSTemp and RefPicList ToRPSTemp may be formed, e.g., using “Pseudo code 1.” The arrays may be used to identify the mapping relationship between the reference picture lists and the physical reference pictures in the DPB. The array RefPicListTemp0, e.g., in the “Pseudo code 1” may be constructed. FIG. 12b illustrates an exemplary array RefPicListTemp0, e.g., for the prediction structure shown in FIG. 12a.

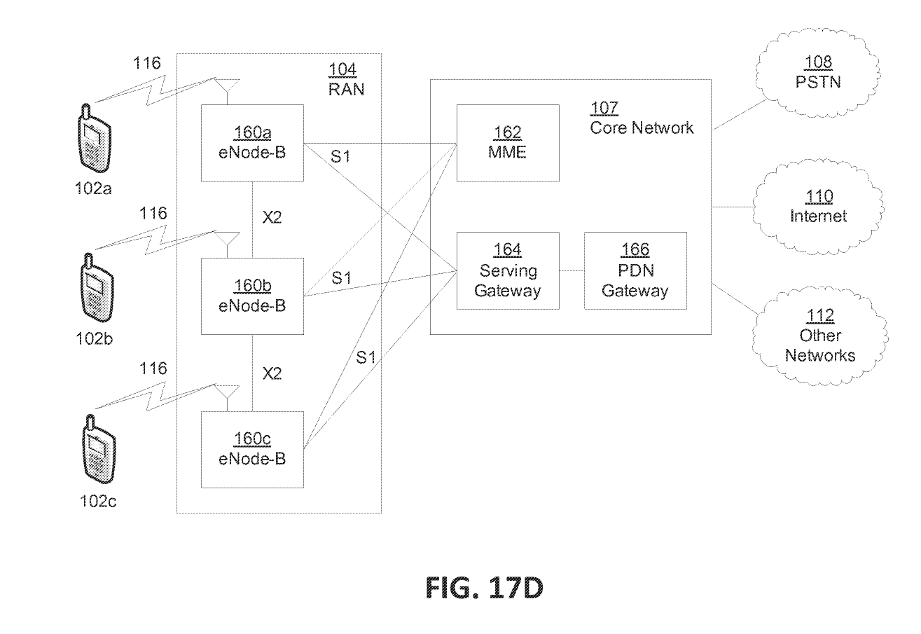

FIG. 16 illustrates an exemplary flow chart for WP parameter prediction, where construction of the arrays RefPicList0ToRPSTemp and RefPicList IToRPSTemp (e.g., using “Pseudo code 1”) is reflected at 1602. At 1604, the prediction WP parameters associated with each reference picture in the DPB may be initialized. For example, “Pseudo code 5” illustrates an exemplary initialization of WP parameters, which may include the weights and offsets for the luma and chroma components for each picture in the DPB.

Pseudo code 5:

// initialize prediction values for physical reference pictures in DPB
for (cIdx = 0; cIdx < NumPocTotalCurr; cIdx ++ ) {

RPSTempLumaWeightPred [ cIdx ] =
(1 << luma_log2_weight_denom )
RPSTempChromaWeightPred [ cIdx ][0] =
RPSTempChromaWeightPred

[ cIdx ][1]

= (1 << ChromaLog2WeightDenom )

RPSTempLumaOffsetPred [cIdx] = 0
RPSTempChromaOffsetPred[cIdx][ 0 ] =
RPSTempChromaOffsetPred[cIdx ][1]

= 0

RPSTempChromaOffsetPredInitialized[ cIdx ] = 0;

}

The WP parameters for the j-th entry on L0 may be signaled and reconstructed as illustrated e.g., in “Pseudo code 6.” The index tempIdx may be set to RefPicList0ToRPSTemp[j]. At 1608, the index tempIdx may reflect the index of the physical reference picture in DPB. The physical reference picture in the DPB may be represented by the j-th entry in L0. At 1610, delta WP parameters may be signaled and received by the decoder. The WP parameters may include delta values associated with the weights and offsets for the luma and chroma components as shown in Table 7.

At 1612, the WP parameters for j-th entry on L0, WPParamL0 [j], may be constructed by summing the prediction values RPSWPParamPred [tempIdx] and the delta values received. At 1614, the corresponding WP parameter prediction values RPSWPParamPred[tempIdx] may be updated by WPParamLO[j] accordingly.

Pseudo code 6:

// for List 0 (L0) WP parameters
for (cIdx = 0; cIdx <= num_ref_idx_list0_active_minus1; cIdx ++ ) {

tempIdx = RefPicList0ToRPSTemp[ cIdx]
LumaWeightL0[ cIdx ] = RPSTempLumaWeightPred[ tempIdx ] +
delta_luma_weight_l0[ cIdx ]
LumaOffsetL0[ cIdx ] = RPSTempLumaOffsetPred[ tempIdx ] + delta_luma_offset_l0[
cIdx ]
ChromaWeightL0[ cIdx ][ 0 ] = RPSTempChromaWeightPred[ tempIdx ][0] +

delta_chroma_weight_l0[ cIdx ][ 0 ]

ChromaWeightL0[ cIdx ][ 1 ] = RPSTempChromaWeightPred[ tempIdx ][ 1 ] +

delta_chroma_weight_l0[ cIdx ][ 1 ]

if ( RPSTempChormaOffsetPredInitialized[ tempIdx ] = = 0 ) {

RPSTempChromaOffsetPred[tempIdx][0] = shift − ( (shift*ChromaWeightL0[ cIdx ][ 0
]) >>

ChromaLog2WeightDenom )

RPSTempChromaOffsetPred[tempIdx][1] = shift − ( (shift*ChromaWeightL0[ cIdx ][ 1
]) >>

ChromaLog2WeightDenom )

RPSTempChromaOffsetPredInitialized[ cIdx ] = 1
}
ChromaOffsetL0[ cIdx ][ 0 ] = RPSTempChromaOffsetPred[tempIdx][0] +

delta_chroma_offset_l0[ cIdx ][ 0 ]

ChromaOffsetL0[ cIdx ][ 1 ] = RPSTempChromaOffsetPred[tempIdx][1] +

delta_chroma_offset_l0[ cIdx ][ 1 ]

// update WP parameter predictions in RPS
RPSTempLumaWeightPred [ tempIdx ] = LumaWeightL0[ cIdx ]
RPSTempLumaOffsetPred [tempIdx] = LumaOffsetL0[ cIdx j
RPSTempChromaWeightPred [ tempIdx ][0] = ChromaWeightL0 [ cIdx ][0]
RPSTempChromaWeightPred [ tempIdx ][1] = ChromaWeightL0 [ cIdx ][1]
RPSTempChromaOffsetPred[tempIdx][ 0 ] = ChromaOffsetL0[ cIdx ][0]
RPSTempChromaOffsetPred[tempIdx][ 1 ] = ChromaOffsetL0[ cIdx ][1]

}

The WP parameters for the j-th entry on L1 may be signaled and reconstructed, e.g., by “Pseudo code 7.” At 1618, the index tempIdx may be set to RefPicList1ToRPSTemp[j]. The index tempIdx may indicate the index of the physical reference picture in DPB represented by the j-th entry in L1. At 1620, a flag such as the delta_params_present_flag, may be signaled to indicate whether a delta WP parameter for the j-th entry on L1 is signaled. At 1622, the delta_params_present_flag, may be checked. If delta_params_present_flag is set to 1, at 1626, the delta WP parameters may be signaled and received by the decoder. Otherwise, at 1624, the delta WP parameters may be set to 0. The parameters may include delta values associated with the weights and offsets for the luma and chroma components as shown in Table 7.

At 1628, the WP parameters for j-th entry on L1. WPParamL1 [j], may be constructed by adding together the prediction values RPSWPParamPred [tempIdx] and the delta values received. At 1630, the corresponding WP parameter prediction values RPSWPParamPred[tempIdx] may be updated to WPParamL0[j] accordingly.

Pseudo code 7:

// for List 1 (L1) WP parameters
if ( weights_l1_present_flag = = 1) {

for (cIdx = 0; cIdx <= num_ref_idx_list1_active_minus1; cIdx ++ ) {
tempIdx = RefPicList1ToRPSTemp[ cIdx]
LumaWeightL1[ cIdx ] = RPSTempLumaWeightPred[ tempIdx ] +
delta_luma_weight_l1[ cIdx ]
LumaOffsetL1[ cIdx ] = RPSTempLumaOffsetPred[ tempIdx ] + delta_luma_offset_l1[
cIdx ]
ChromaWeightL1[ cIdx ][ 0 ] = RPSTempChromaWeightPred[ tempIdx ][ 0 ] +

delta_chroma_weight_l1[ cIdx ][ 0 ]

ChromaWeightL1[ cIdx ][ 1 ] = RPSTempChromaWeightPred[ tempIdx ][ 1 ] +

delta_chroma_weight_l1[ cIdx ]

if ( RPSTempChormaOffsetPredInitialized[ tempIdx ] = = 0 ) {
RPSTempChromaOffsetPred[tempIdx][0] = shift − ( (shift*ChromaWeightL1[ cIdx ][ 0
]) >>

ChromaLog2WeightDenom )

RPSTempChromaOffsetPred[tempIdx][1] = shift − ( (shift*ChromaWeightL1[ cIdx ][ 1
])>>

ChromaLog2WeightDenom )

RPSTempChromaOffsetPredInitialized[ cIdx ] = 1
}
ChromaOffsetL1[ cIdx ][ 0 ] = RPSTempChromaOffsetPred[tempIdx][0] +
delta_chroma_offset_l1[ cIdx ][ 0 ]
ChromaOffsetL1[ cIdx ][ 1 ] = RPSTempChromaOffsetPred[tempIdx][1] +
delta_chroma_offset_l1[ cIdx ][ 1 ]
// update WP parameter predictions in RPS
RPSTempLumaWeightPred [ tempIdx ] = LumaWeightL1[ cIdx ]
RPSTempLumaOffsetPred [tempIdx] = LumaOffsetL1[ cIdx ]
RPSTempChromaWeightPred [ tempIdx ][0] = ChromaWeightL1 [ cIdx ][0]
RPSTempChromaWeightPred[ tempIdx ][1] = ChromaWeightL1 [ cIdx ][1]
RPSTempChromaOffsetPred[tempIdx][ 0 ] = ChromaOffsetL1[ cIdx ][0]
RPSTempChromaOffsetPred[tempIdx][ 1 ] = ChromaOffsetL1[ cIdx ][1]
}

} else { // L1 identical to L0 and uses the same WP parameters

for (cIdx = 0; cIdx <= num_ref_idx_list1_active_minus1; cIdx ++ ) {

LumaWeightL1[ cIdx ] = L0L1IdenticalFlag ? LumaWeightL0[ cIdx ] : (1 <<

luma_log2_weight_denom)

LumaOffsetL1[ cIdx ] = L0L1IdenticalFlag ? LumaOffsetL0[ cIdx ] : 0
ChromaWeightL1[ cIdx ][ 0 ] = L0L1IdenticalFlag ? ChromaWeightL0[ cIdx ][ 0 ] :

(1 <<

ChromaLog2WeightDenom)

ChromaWeightL1[ cIdx ][ 1 ] = L0L1IdenticalFlag ? ChromaWeightL0[ cIdx ][ 1 ] :
(1 <<

ChromaLog2WeightDenom)

ChromaOffsetL1[ cIdx ][ 0 ] = L0L1IdenticalFlag ? ChromaOffsetL0[ cIdx ][ 0 ] : 0
ChromaOffsetL1[ cIdx ][ 1 ] = L0L1IdenticalFlag ? ChromaOffsetL0[ cIdx ][ 1 ] : 0

}

}

WP parameter signaling for L1 may be substantially similar to the WP parameter signaling for L0. The WP parameter signaling may include a flag such as the delta_params_present_flag, which may be used to by-pass signaling of the delta WP parameters associated with the j-th entry in L1. For example, when delta_params_present_flag is set to 0, delta WP parameters may be set to 0, and the corresponding WP parameters for the j-th entry in L1 may be set to the same as the prediction values. This flag may be an efficient way to signal the WP parameters for an L1 entry that may include an overlapping entry with an entry in L0, and may have the same WP parameters as its overlapping L0 entry. L0 signaling may include a delta_params_present_flag. Signaling of the flag delta_params_present_flag may be conditioned upon whether the reference picture in DPB corresponding to the j-th entry of L1 may have already appeared as an earlier entry in L0 or L1. For example, whether the reference picture in DPB corresponding to the j-th entry of L1 may have already appeared as an earlier entry in L0 or L1 may be determined using the same or similar logic used to determine the value of RPSTempChormaOffsetPredInitialized e.g., in “Pseudo code 7.” The flag delta_params_present_flag may be inferred to be equal to 1, when the reference picture in DPB corresponding to the j-th entry of L1 has not appeared as an earlier entry, e.g., delta_params_present_flag is not explicitly signaled in the bitstream. Setting the flag delta_params_present_flag to 1 may indicate that delta WP parameters for j-th entry in L1 may be signaled. Although not shown in Table 7, L0 signaling may include a delta_params_present_flag to indicate whether delta WP parameters for the j-th entry in L0 may be signaled or not.

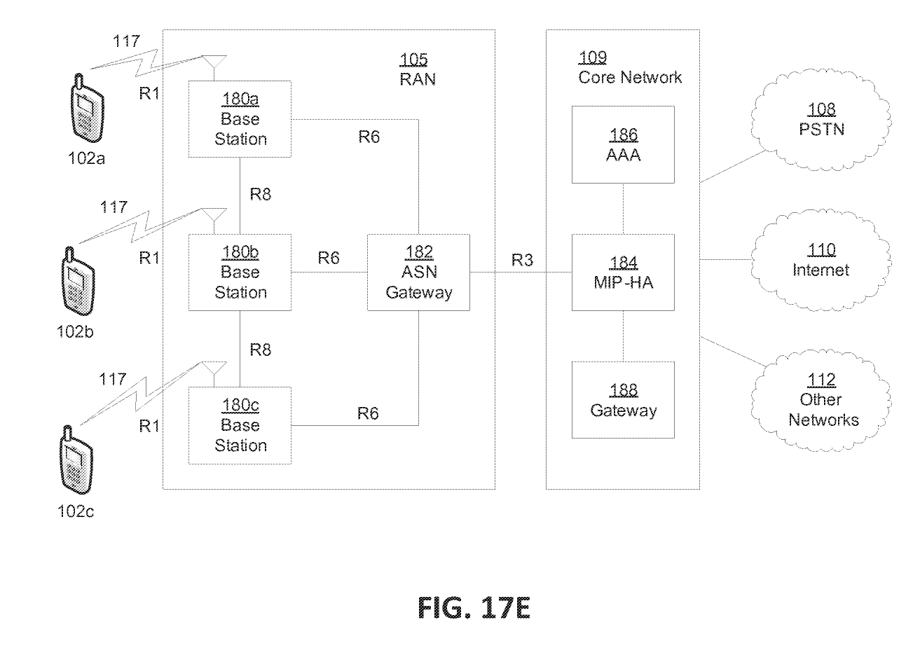

FIG. 17A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 17A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include wireless transmit/receive unit (WTRU), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA. FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In an embodiment, the base station 114a and the WTRUs 102a, 102b, 102c may implement radio technologies such as IEEE 802.16 (i.e., Worldwide Interoperability for Microwave Access (WiMAX)), CDMA2000. CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 17A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 17A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 17A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with a RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include a core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 17A may be configured to communicate with the base station 114a, which may employ a cellular-based radio technology, and with the base station 114b, which may employ an IEEE 802 radio technology.

FIG. 17B is a system diagram of an example WTRU 102. As shown in FIG. 17B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or each of the elements depicted in FIG. 17B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 17B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 17B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 17C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 17C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 17C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an lub interface. The RNCs 142a, 142b may be in communication with one another via an lur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro diversity, security functions, data encryption, and the like.

The core network 106 shown in FIG. 17C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 17D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 8D, the eNode-Bs 160a, 160b, 160c may communicate with one another over an X2 interface.

The core network 107 shown in FIG. 8D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 17E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 17E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 17E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 17E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

One of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1-32. (canceled)

33. A method of weighted prediction (WP) signaling, the method comprising:
receiving a first plurality of WP parameters, wherein each of the first plurality of WP parameters is associated with an entry of a first reference picture list;
receiving a flag;
determining a value of the flag; and
on a condition that the value of the flag is a first value and a second reference picture list is identical to the first reference picture list, setting a second plurality of WP parameters associated with respective entries of the second reference picture list by copying the WP parameters from corresponding entries of the first reference picture list.

34. The method of claim 33, wherein on a condition that the value of the flag is the first value and the second reference picture list is not identical to the first reference picture list, setting values for the second plurality of WP parameters associated with the second reference picture list to one or more default values.

35. The method of claim 33, wherein the first plurality of WP parameters or the second plurality of WP parameters comprise one or more of a luma weight, a chroma weight, a luma offset, or a chroma offset.

36. The method of claim 33, wherein on a condition that the value of the flag is a second value:
receiving a plurality of signaled values in a bitstream; and
setting the second plurality of WP parameters associated with the second reference picture list based on the signaled values.

37. The method of claim 36, further comprising:
receiving a presence flag;
determining the value of the presence flag; and
on a condition that the value of the presence flag is a first value:
receiving, via a video bitstream, a signaled value;
calculating, based the received signaled value, a WP parameter associated with an entry of the second reference picture list; and
on a condition that the value of the presence flag is a second value, setting the WP parameter associated with the entry of the second reference picture list based on a predicted value.

38. A method of weighted prediction (WP) signaling, the method comprising:
receiving a first plurality of WP parameters in a video bitstream, wherein each of the first plurality of WP parameters is associated with an entry of a first reference picture list;
receiving a flag;
determining a value of the flag; and
on a condition that the value of the flag is a first value, setting a second plurality of WP parameters associated with entries of a second reference picture list by reusing the WP parameters associated with the entries of the first reference picture list that are relevant to the second reference picture list.

39. The method of claim 38, wherein on a condition that the flag is set to a second value, receiving, via the video bitstream, the WP parameters for one or more second reference picture list entries that have corresponding entries in the first reference picture list.

40. The method of claim 38, wherein the second reference picture list is not identical to the first reference picture list.

41. A video coding device comprising:
a processor configured to at least:
receive a first plurality of WP parameters, wherein each of the first plurality of WP parameters is associated with an entry of a first reference picture list;
receive a flag;
determine a value of the flag; and
on a condition that the value of the flag is a first value and a second reference picture list is identical to the first reference picture list, set a second plurality of WP parameters associated with entries of the second reference picture list by copying the WP parameters from corresponding entries of the first reference picture list.

42. The video coding device of claim 41, wherein on a condition that the value of the flag is the first value and the second reference picture list is not identical to the first reference picture list, the processor is further configured to set values for the second plurality of WP parameters associated with the second reference picture list to one or more default values.

43. The video coding device of claim 41, wherein the first plurality of WP parameters or the second plurality of WP parameters comprise one or more of a luma weight, a chroma weight, a luma offset, or a chroma offset.

44. The video coding device of claim 41, wherein on a condition that the value of the flag is a second value, the processor is further configured to:
receive a plurality of signaled values in a bitstream; and
set the second plurality of WP parameters associated with the second reference picture list based on the signaled values.

45. The video coding device of claim 44, wherein the processor is further configured to:
receive a presence flag;
determine the value of the presence flag; and
on a condition that the value of the presence flag is a first value:
receive, via a video bitstream, a signaled value;
calculate, based the received signaled value, a WP parameter associated with an entry of the second reference picture list; and
on a condition that the value of the presence flag is a second value, set the WP parameter associated with the entry of the second reference picture list based on a predicted value.

46. A video coding device comprising:
A processor configured to at least:
receive a first plurality of WP parameters in a video bitstream, wherein each of the first plurality of WP parameters is associated with an entry of a first reference picture list;
receive a flag;
determine a value of the flag; and
on a condition that the value of the flag is a first value, set a second plurality of WP parameters associated with entries of a second reference picture list by reusing the WP parameters associated with the entries of the first reference picture list that are relevant to the second reference picture list.

47. The video coding device of claim 46, wherein on a condition that the flag is set to a second value, the processor is further configured to receive, via the video bitstream, the WP parameters for one or more second reference picture list entries that have corresponding entries in the first reference picture list.

48. The video coding device of claim 46, wherein the second reference picture list is not identical to the first reference picture list.
